(19) United States
(12) Patent Application Publication
(10) Pub. No.: US 2026/0227668 A1
(43) Pub. Date: Aug. 6, 2026

(54) ELECTROPHORETIC ELEMENT AND DISPLAY DEVICE

(71) Applicant: Sharp Display Technology Corporation, Kameyama City (JP)

(72) Inventors: Kimiaki NAKAMURA, Kameyama City (JP); Takashi SATO, Kameyama City (JP)

(21) Appl. No.: 19/459,204

(22) Filed: Jan. 26, 2026

(30) Foreign Application Priority Data
Jan. 31, 2025 (JP) 2025-015038

(51) Int. Cl. G02F 1/1676; G02F 1/167

(52) U.S. Cl. CPC G02F 1/1676; G02F 1/167

(57) ABSTRACT

An electrophoretic element includes a first substrate, a second substrate, and an electrophoretic layer, and includes a plurality of pixels. The electrophoretic element further includes, in each pixel, a first electrode arranged in a manner as to be not located in an opening region, a plurality of second electrodes arranged in a manner as to be at least partially located within the opening region, and a plurality of third electrodes arranged in a manner as to be at least partially located within the opening region and configured such that a potential different from that applied to the plurality of second electrodes is applied to at least one of the plurality of third electrodes. In a plan view, the second electrodes and the third electrodes are alternately arranged along a predetermined direction.

### CROSS-REFERENCE TO RELATED APPLICATIONS

This application claims the benefit of priority to Japanese Patent Application Number 2025-015038 filed on January 31, 2025. The entire contents of the above-identified application are hereby incorporated by reference.

### BACKGROUND

### TECHNICAL FIELD

The disclosure relates to an electrophoretic element and an electrowetting element. The disclosure also relates to a display device including an electrophoretic element or an electrowetting element.

In recent years, transparent displays, which are transparent and allow a back side of the display to be seen, have been attracting attention. JP 2012-238544 A discloses a transparent display that uses an organic electroluminescence (EL) display panel as a display panel.

The transparent displays suffer from issues such as image distortion and a reduction in contrast ratio due to light transmitted from the back side. Thus, Cheng-Chang Li et. al., "High-image-quality Transparent Display based on AM-OLED with Cholesteric Liquid Crystal Back-panel", SID 2018 DIGEST, 2018, pp. 993-995, proposes a technology in which a liquid crystal panel that functions as a light shutter panel is placed on a back side of an organic EL display panel. By blocking light from the back side using the liquid crystal panel, image distortion and a reduction in contrast ratio are suppressed.

### SUMMARY

The inventors of this application have conceived of using a transverse electrical field electrophoretic element as a light shutter panel. In the transverse electrical field electrophoretic element, a transverse electrical field generated by a pair of electrodes is used to move electrophoretic particles (charged particles) in an electrophoretic layer. By switching a direction of the transverse electrical field, it is possible to switch between a state in which charged particles are located within a light blocking region of a pixel (a state in which charged particles are located on one of the pair of electrodes) and a state in which charged particles are dispersed within an opening region of the pixel (a state in which charged particles are dispersed on another electrode).

After extensive research, the inventors of this application have discovered a problem that, in the transverse electrical field electrophoretic element, dispersion of charged particles within the opening region becomes non-uniform. This is due to a distribution of a transverse electrical field generated within the pixel.

The inventors of this application have also investigated use of an electrowetting element as a light shutter panel, and have found that the electrowetting element also has the same problem, namely, a risk that a droplet may not move suitably to the opening region.

Embodiments of the disclosure have been made in light of the above problems, and a purpose thereof is to provide a transverse electrical field electrophoretic element capable of uniformly dispersing electrophoretic particles within an opening region of a pixel and/or an electrowetting element capable of suitably moving a droplet into an opening region of a pixel.

This specification discloses an electrophoretic element, an electrowetting element, and a display device described in the following items.

### Item 1

An electrophoretic element including a first substrate and a second substrate facing each other, an electrophoretic layer provided between the first substrate and the second substrate, and a plurality of pixels each including an opening region configured to transmit light from the electrophoretic layer to a front side, the electrophoretic layer including a dispersion medium and a plurality of electrophoretic particles dispersed in the dispersion medium in each of the plurality of pixels, in which, in each of the plurality of pixels, the electrophoretic element further includes a first electrode arranged in a manner as to be not located within the opening region, a plurality of second electrodes arranged in a manner as to be at least partially located within the opening region, and a plurality of third electrodes arranged in a manner as to be at least partially located within the opening region and configured such that a potential different from a potential applied to the plurality of second electrodes is applied to at least one of the plurality of third electrodes, and, in a plan view, one of the plurality of second electrodes and one of the plurality of third electrodes are alternately arranged along a predetermined direction.

### Item 2

The electrophoretic element according to Item 1, in which the plurality of second electrodes and the plurality of third electrodes do not overlap each other in a plan view.

### Item 3

The electrophoretic element according to Item 1 or 2, in which in each of the plurality of pixels, potentials applied to the plurality of second electrodes are identical to each other, and potentials applied to the plurality of third electrodes are identical to each other.

### Item 4

The electrophoretic element according to Item 3, in which during transition of each of the plurality of pixels from a state where the plurality of electrophoretic particles are located near the first electrode to a state where the plurality of electrophoretic particles are located within the opening region, DC voltages of opposite phases are applied to the plurality of second electrodes and the plurality of third electrodes.

### Item 5

The electrophoretic element according to Item 1 or 2, in which in each of the plurality of pixels, the plurality of second electrodes include two second electrodes to which potentials different from each other are applied, and the plurality of third electrodes include two third electrodes to which potentials different from each other are applied.

### Item 6

The electrophoretic element according to Item 5, in which in each of the plurality of pixels, a potential applied to a certain second electrode of the plurality of second electrodes is identical to a potential applied to a certain third electrode of the plurality of third electrodes.

### Item 7

The electrophoretic element according to Item 5 or 6, in which of a positive polarity and a negative polarity, a polarity to which the plurality of electrophoretic particles are charged is defined as a first polarity, and a polarity opposite to the first polarity is defined as a second polarity, and further, of the plurality of second electrodes and the plurality of third electrodes, an electrode closest to the first electrode, an electrode second closest to the first electrode, and an electrode third closest to the first electrode are defined as a first proximal electrode, a second proximal electrode, and a third proximal electrode, respectively, during transition of each of the plurality of pixels from a state where the plurality of electrophoretic particles are located near the first electrode to a state where the plurality of electrophoretic particles are located within the opening region, the following states are sequentially formed by applying DC voltages to the plurality of second electrodes and the plurality of third electrodes:
(1) a state where the first proximal electrode is at the second polarity and the second proximal electrode and the third proximal electrode are at a ground potential or the first polarity,
(2) a state where the second proximal electrode is at the second polarity and the first proximal electrode and the third proximal electrode are at the ground potential or the first polarity, and
(3) a state where the third proximal electrode is at the second polarity and the first proximal electrode and the second proximal electrode are at the ground potential or the first polarity.

### Item 8

The electrophoretic element according to Item 7, in which a length of time t1 during which a DC voltage of the second polarity is applied to the first proximal electrode, a length of time t2 during which a DC voltage of the second polarity is applied to the second proximal electrode, and a length of time t3 during which a DC voltage of the second polarity is applied to the third proximal electrode satisfy a relationship t1 > t2 > t3.

### Item 9

The electrophoretic element according to Item 7, in which a length of time t1 during which a DC voltage of the second polarity is applied to the first proximal electrode, a length of time t2 during which a DC voltage of the second polarity is applied to the second proximal electrode, and a length of time t3 during which a DC voltage of the second polarity is applied to the third proximal electrode satisfy a relationship t1 < t2 < t3.

### Item 10

The electrophoretic element according to any one of Items 7 to 9, in which a magnitude V1 of a DC voltage of the second polarity applied to the first proximal electrode, a magnitude V2 of a DC voltage of the second polarity applied to the second proximal electrode, and a magnitude V3 of a DC voltage of the second polarity applied to the third proximal electrode satisfy a relationship V1 > V2 > V3.

### Item 11

The electrophoretic element according to any one of Items 7 to 9, in which a magnitude V1 of a DC voltage of the second polarity applied to the first proximal electrode, a magnitude V2 of a DC voltage of the second polarity applied to the second proximal electrode, and a magnitude V3 of a DC voltage of the second polarity applied to the third proximal electrode satisfy a relationship V1 < V2 < V3.

### Item 12

The electrophoretic element according to any one of Items 1 to 11, in which the first electrode of each of the plurality of pixels is electrically independent of the first electrodes of other pixels.

### Item 13

The electrophoretic element according to Item 12 further including a thin film transistor provided in each of the plurality of pixels, a gate wiring line electrically connected to a gate electrode of the thin film transistor, and a source wiring line electrically connected to a source electrode of the thin film transistor, in which the first electrode of each of the plurality of pixels is electrically connected to a drain electrode of the thin film transistor.

### Item 14

The electrophoretic element according to Item 13, in which the plurality of pixels are arranged in a matrix including a plurality of rows and a plurality of columns, the gate wiring line extends along a row direction, and the source wiring line extends along a column direction, and the plurality of second electrodes and the plurality of third electrodes each are a common electrode extending along the column direction and configured such that a common potential across an entire one pixel column is applied.

### Item 15

The electrophoretic element according to any one of items 1 to 14, in which the first substrate includes the plurality of second electrodes, and the second substrate includes the plurality of third electrodes.

### Item 16

The electrophoretic element according to any one of Items 1 to 14, in which one of the first substrate and the second substrate includes the plurality of second electrodes and the plurality of third electrodes.

### Item 17

A display device including a self-luminous display panel, and the electrophoretic element according to any one of Items 1 to 16, configured to overlap the display panel.

### Item 18

An electrowetting element including a first substrate, a second substrate arranged facing the first substrate with a space interposed between the first substrate and the second substrate, and a plurality of pixels each including an opening region configured to transmit light from the space to a front side, a droplet being arranged in the space in each of the plurality of pixels, at least one of the first substrate and the second substrate including a water-repellent layer provided facing the space, in which, in each of the plurality of pixels, the electrowetting element further includes a first electrode arranged in a manner as to include a portion not located within the opening region, a plurality of second electrodes arranged in a manner as to be at least partially located within the opening region, and a plurality of third electrodes arranged in a manner as to be at least partially located within the opening region and configured such that a potential different from a potential applied to the plurality of second electrodes is applied to at least one of the plurality of third electrodes, and, in a plan view, one of the plurality of second electrodes and one of the plurality of third electrodes are alternately arranged along a predetermined direction.

### Item 19

The electrowetting element according to Item 18, in which in each of the plurality of pixels, potentials applied to the plurality of second electrodes are identical to each other, and potentials applied to the plurality of third electrodes are identical to each other.

### Item 20

The electrowetting element according to Item 19, in which during transition of each of the plurality of pixels from a state where the droplet is located near the first electrode to a state where the droplet is located within the opening region, DC voltages of opposite phases are applied to the plurality of second electrodes and the plurality of third electrodes.

### Item 21

The electrowetting element according to Item 18, in which in each of the plurality of pixels, the plurality of second electrodes include two second electrodes to which potentials different from each other are applied, and the plurality of third electrodes include two third electrodes to which potentials different from each other are applied.

### Item 22

The electrowetting element according to Item 21, in which in each of the plurality of pixels, a potential applied to a certain second electrode of the plurality of second electrodes is identical to a potential applied to a certain third electrode of the plurality of third electrodes.

### Item 23

The electrowetting element according to any one of Items 18 to 22, in which the first substrate includes the plurality of second electrodes, and the second substrate includes the plurality of third electrodes.

### Item 24

The electrowetting element according to any one of Items 18 to 22, in which one of the first substrate and the second substrate includes the plurality of second electrodes and the plurality of third electrodes.

### Item 25

A display device including a self-luminous display panel, and the electrowetting element according to any one of Items 18 to 24, configured to overlap the display panel.

According to the embodiments of the disclosure, it is possible to provide a transverse electrical field electrophoretic element capable of uniformly dispersing electrophoretic particles within an opening region of a pixel, and/or an electrowetting element capable of suitably moving a droplet into an opening region of a pixel.

### BRIEF DESCRIPTION OF DRAWINGS

The disclosure will be described with reference to the accompanying drawings, wherein like numbers reference like elements.

FIG. 1 is a cross-sectional view schematically illustrating an electrophoretic element 100 according to an embodiment of the disclosure, illustrating a region corresponding to one pixel Px of the electrophoretic element 100.

FIG. 2 is a plan view schematically illustrating the electrophoretic element 100.

FIG. 3 is a diagram illustrating a light transmitting state of the pixel Px.

FIG. 4 is a diagram illustrating an example of voltage waveforms when achieving a light transmitting state.

FIG. 5A is a diagram illustrating how the pixel Px is transitioned from the light transmitting state to a light blocking state.

FIG. 5B is a diagram illustrating how the pixel Px is transitioned from the light transmitting state to the light blocking state.

FIG. 5C is a diagram illustrating how the pixel Px is transitioned from the light transmitting state to the light blocking state.

FIG. 5D is a diagram illustrating how the pixel Px is transitioned from the light transmitting state to the light blocking state.

FIG. 6 is a diagram illustrating an example of voltage waveforms when achieving the light blocking state.

FIG. 7 is a diagram illustrating an example of voltage waveforms when achieving the light blocking state after initialization.

FIG. 8 is a cross-sectional view schematically illustrating an electrophoretic element 900 according to a comparative example.

FIG. 9A is a diagram illustrating how the pixel Px is brought into a light transmitting state.

FIG. 9B is a diagram illustrating how the pixel Px is transitioned from the light transmitting state to a light blocking state.

FIG. 9C is a diagram illustrating how the pixel Px is transitioned from the light transmitting state to the light blocking state.

FIG. 9D is a diagram illustrating how the pixel Px is transitioned from the light transmitting state to the light blocking state.

FIG. 9E is a diagram illustrating how the pixel Px is transitioned from the light transmitting state to the light blocking state.

FIG. 10 is a diagram illustrating an example of voltage waveforms used in a voltage application mode illustrated in FIGS. 9A to 9E.

FIG. 11A is a diagram illustrating another example of voltage waveforms.

FIG. 11B is a diagram illustrating still another example of voltage waveforms.

FIG. 12A is a diagram illustrating yet another example of voltage waveforms.

FIG. 12B is a diagram illustrating a further example of voltage waveforms.

FIG. 13 is a plan view illustrating an example of a specific configuration of the electrophoretic element 100.

FIG. 14 is a plan view illustrating another example of a specific configuration of the electrophoretic element 100.

FIG. 15A is a diagram illustrating an example of waveforms of a gate signal and a source signal when achieving the light transmitting state.

FIG. 15B is a diagram illustrating an example of waveforms of the gate signal and the source signal when transitioning the pixel Px from the light transmitting state to the light blocking state.

FIG. 16 is a cross-sectional view schematically illustrating another electrophoretic element 100A according to an embodiment of the disclosure, illustrating a region corresponding to one pixel Px of the electrophoretic element 100A.

FIG. 17 is a diagram illustrating a light transmitting state of the pixel Px.

FIG. 18 is a diagram illustrating an example of voltage waveforms when achieving a light transmitting state.

FIG. 19A is a diagram illustrating how the pixel Px is transitioned from the light transmitting state to a light blocking state.

FIG. 19B is a diagram illustrating how the pixel Px is transitioned from the light transmitting state to the light blocking state.

FIG. 19C is a diagram illustrating how the pixel Px is transitioned from the light transmitting state to the light blocking state.

FIG. 19D is a diagram illustrating how the pixel Px is transitioned from the light transmitting state to the light blocking state.

FIG. 20 is a diagram illustrating an example of voltage waveforms when achieving the light blocking state.

FIG. 21 is a diagram illustrating an example of voltage waveforms when achieving the light blocking state after initialization.

FIG. 22A is a diagram illustrating how the pixel Px is brought into a light transmitting state.

FIG. 22B is a diagram illustrating how the pixel Px is transitioned from the light transmitting state to a light blocking state.

FIG. 22C is a diagram illustrating how the pixel Px is transitioned from the light transmitting state to the light blocking state.

FIG. 22D is a diagram illustrating how the pixel Px is transitioned from the light transmitting state to the light blocking state.

FIG. 22E is a diagram illustrating how the pixel Px is transitioned from the light transmitting state to the light blocking state.

FIG. 23 is a diagram illustrating an example of voltage waveforms used in a voltage application mode illustrated in FIGS. 22A to 22E.

FIG. 24 is a diagram schematically illustrating a transparent display (display device) 400 that includes the electrophoretic element 100 (or 100A) as a light shutter panel.

FIG. 25 is a diagram illustrating a state in which an image is displayed in a portion of a displayable region of a display panel 300 (image display region) DR and no image is displayed in another region (transparent region) TR, in the transparent display (display device) 400.

FIG. 26 is a cross-sectional view schematically illustrating an electrowetting element 200 according to an embodiment of the disclosure, illustrating a region corresponding to one pixel Px of the electrowetting element 200.

FIG. 27 is a plan view schematically illustrating the electrowetting element 200.

FIG. 28 is a diagram illustrating a light transmitting state of the pixel Px.

FIG. 29 is a diagram illustrating an example of voltage waveforms when achieving a light transmitting state.

FIG. 30A is a diagram illustrating how the pixel Px is transitioned from the light transmitting state to a light blocking state.

FIG. 30B is a diagram illustrating how the pixel Px is transitioned from the light transmitting state to the light blocking state.

FIG. 30C is a diagram illustrating how the pixel Px is transitioned from the light transmitting state to the light blocking state.

FIG. 30D is a diagram illustrating how the pixel Px is transitioned from the light transmitting state to the light blocking state.

FIG. 31 is a diagram illustrating an example of voltage waveforms when achieving the light blocking state.

FIG. 32 is a diagram illustrating an example of voltage waveforms when achieving the light blocking state after initialization.

FIG. 33 is a diagram illustrating another example of voltage waveforms.

FIG. 34 is a cross-sectional view schematically illustrating another electrowetting element 200A according to an embodiment of the disclosure, illustrating a region corresponding to one pixel Px of the electrowetting element 200A.

FIG. 35 is a diagram illustrating an example of voltage waveforms when achieving a light transmitting state.

FIG. 36A is a diagram illustrating how the pixel Px is transitioned from the light transmitting state to a light blocking state.

FIG. 36B is a diagram illustrating how the pixel Px is transitioned from the light transmitting state to the light blocking state.

FIG. 36C is a diagram illustrating how the pixel Px is transitioned from the light transmitting state to the light blocking state.

FIG. 36D is a diagram illustrating how the pixel Px is transitioned from the light transmitting state to the light blocking state.

FIG. 37 is a diagram illustrating an example of voltage waveforms when achieving the light blocking state.

FIG. 38 is a diagram illustrating an example of voltage waveforms when achieving the light blocking state after initialization.

FIG. 39 is a diagram illustrating another example of voltage waveforms.

FIG. 40 is a diagram schematically illustrating a transparent display (display device) 500 including the electrowetting element 200 (or 200A) as a light shutter panel.

FIG. 41 is a diagram illustrating a state in which an image is displayed in a portion of a displayable region of a display panel 300 (image display region) DR and no image is displayed in another region (transparent region) TR in the transparent display (display device) 500.

### DESCRIPTION OF EMBODIMENTS

Hereinafter, embodiments of the disclosure will be described with reference to the accompanying drawings. Note that the disclosure is not limited to the embodiments described below.

### First Embodiment

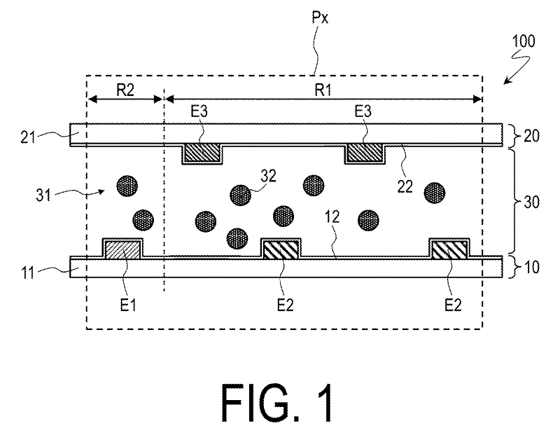

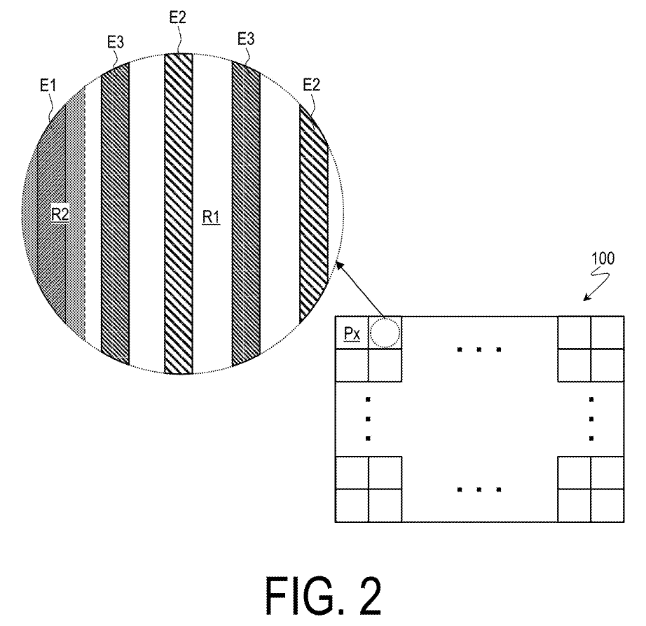

An electrophoretic element 100 according to a present embodiment will be described with reference to FIGS. 1 and 2. FIGS. 1 and 2 are a cross-sectional view and a plan view, respectively, schematically illustrating the electrophoretic element 100. FIG. 1 illustrates a region corresponding to one pixel Px of the electrophoretic element 100. The electrophoretic element 100 according to the present embodiment is suitably used as, for example, a light shutter panel.

As illustrated in FIG. 1, the electrophoretic element 100 includes a first substrate 10 and a second substrate 20 facing each other, and an electrophoretic layer 30 provided between the first substrate 10 and the second substrate 20. Here, a lower side in FIG. 1 is a front side of the electrophoretic element 100, and an upper side in FIG. 1 is a back side of the electrophoretic element 100. That is, the first substrate 10 is positioned on the front side, and the second substrate 20 is positioned on the back side.

The electrophoretic element 100 has a plurality of pixels Px, as illustrated in FIG. 2. The plurality of pixels Px are arrayed in a matrix including a plurality of rows and a plurality of columns. Each of the plurality of pixels Px includes an opening region R1. The opening region R1 is a region through which light passes from the electrophoretic layer 30 to the front side. In each pixel Px, a region R2 other than the opening region R1 is provided with a light blocking layer (not illustrated here) positioned on the front side of the electrophoretic layer 30. Hereinafter, the region R2 may be referred to as a "light blocking region".

The electrophoretic layer 30 contains, in each pixel Px, a dispersion medium 31 and a plurality of electrophoretic particles 32 dispersed in the dispersion medium 31. In the present embodiment, the electrophoretic particles 32 are black (that is, black particles). In the present embodiment, the electrophoretic particles 32 are charged with a negative polarity. A diameter of each of the electrophoretic particles 32 is not particularly limited, but is, for example, several hundred nm.

The first substrate 10 includes a first electrode E1 and a plurality of second electrodes E2 in each pixel Px. The first electrode E1 is located so as not to be positioned within the opening region R1. That is, the first electrode E1 is located within the light blocking region R2. In contrast, the plurality of second electrodes E2 are located so as to be at least partially positioned within the opening region R1.

The first substrate 10 further includes a transparent substrate 11. The transparent substrate 11 is, for example, a glass substrate with a thickness of 0.7 mm. The first electrode E1 and the plurality of second electrodes E2 are provided on an electrophoretic layer 30 side of the transparent substrate 11, and are supported by the transparent substrate 11. The first electrode E1 and the plurality of second electrodes E2 can be formed, for example, by depositing an ITO film with a thickness of 0.1 μm by sputtering, and then patterning the ITO film by a photolithography process and etching.

The second substrate 20 includes a plurality of third electrodes E3 in each pixel Px. The plurality of third electrodes E3 are located so as to be at least partially positioned within the opening region R1. A potential different from that applied to the plurality of second electrodes E2 is applied to at least one of the plurality of third electrodes E3.

The second substrate 20 further includes a transparent substrate 21. The transparent substrate 21 is, for example, a glass substrate with a thickness of 0.7 mm. The plurality of third electrodes E3 are provided on an electrophoretic layer 30 side of the transparent substrate 21, and are supported by the transparent substrate 21. The plurality of third electrodes E3 can be formed, for example, by depositing an ITO film with a thickness of 0.1 μm by sputtering, and then patterning the ITO film by a photolithography process and etching.

In the illustrated example, a first surface modification layer 12 is formed so as to cover the transparent substrate 11, the first electrode E1, and the plurality of second electrodes E2. A second surface modification layer 22 is formed so as to cover the transparent substrate 21 and the plurality of third electrodes E3. Each of the first surface modification layer 12 and the second surface modification layer 22 is, for example, a fluororesin layer having a thickness equivalent to several molecular layers. By forming the first surface modification layer 12 and the second surface modification layer 22, it is possible to suppress adhesion of the electrophoretic particles 32 to the first substrate 10 and the second substrate 20.

A distance between the first substrate 10 and the second substrate 20 (i.e., a thickness of the electrophoretic layer 30) is, for example, 15 μm, and is defined by spacers (not illustrated).

In the present embodiment, in a plan view, one of the plurality of second electrodes E2 and one of the plurality of third electrodes E3 are alternately arranged along a predetermined direction. In the illustrated example, the third electrode E3, the second electrode E2, the third electrode E3, and the second electrode E2 are arranged in this order along a direction from a left side to a right side in the figure. In the present embodiment, in each pixel Px, the plurality of second electrodes E2 and the plurality of third electrodes E3 do not overlap each other in a plan view.

Note that an example is illustrated here in which the first substrate 10 includes the first electrode E1, but the second substrate 20 may include the first electrode E1. The number of the second electrodes E2 and the number of the third electrodes E3 are not limited to two, as exemplified in FIG. 1. Shapes of the first electrode E1, the second electrodes E2, and the third electrodes E3 are not limited to the illustrated shape (strip shape).

Next, the operation of the electrophoretic element 100 will be described.

When an electrical field is formed in the electrophoretic layer 30, a direction in which the electrophoretic particles 32 move is determined by a charge polarity of the electrophoretic particles 32 and a direction of the electrical field. In the present embodiment, the electrophoretic particles 32 are charged with a negative polarity, so the electrophoretic particles 32 move in a direction opposite to a direction of lines of electric force (naturally, when the electrophoretic particles 32 are charged with a positive polarity, the electrophoretic particles 32 move in the direction of the lines of electric force). By controlling potentials of the first electrode E1, the plurality of second electrodes E2, and the plurality of third electrodes E3, the electrophoretic element 100 can switch between a state in which the opening region R1 transmits light (hereinafter referred to as a "light transmitting state" of the pixel Px) and a state in which the opening region R1 blocks light (hereinafter referred to as a "light blocking state" of the pixel Px).

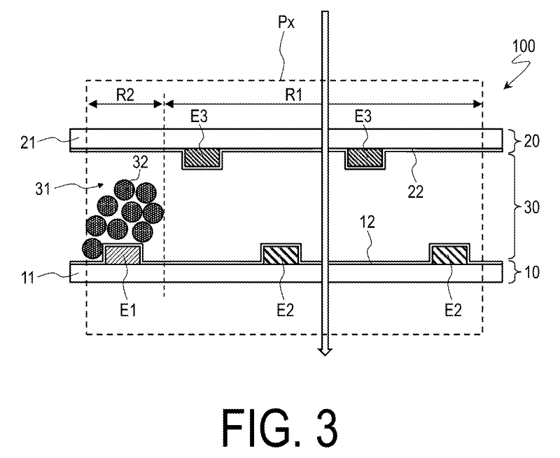

FIG. 3 illustrates the light transmitting state described above. By applying a potential of an opposite polarity to that of the electrophoretic particles 32, that is, a positive potential, to the first electrode E1, the electrophoretic particles 32 move toward the first electrode E1. Thus, as illustrated in FIG. 3, the light transmitting state can be achieved in which the electrophoretic particles 32 are not located within the opening region R1 (i.e., are located near the first electrode E1 within the light blocking region R2). At this time, for example, a ground potential (0 V) is applied to the second electrodes E2 and the third electrodes E3.

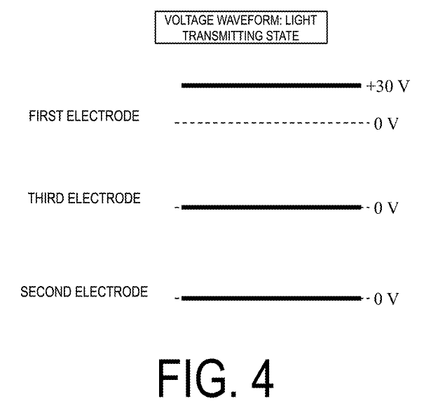

FIG. 4 illustrates an example of waveforms of voltages applied to the first electrode E1, the second electrodes E2, and the third electrodes E3, when achieving the light transmitting state. In the example illustrated in FIG. 4, the voltage applied to the first electrode E1 is a DC voltage of +30 V, and the voltage applied to the second electrodes E2 and the third electrodes E3 is 0 V (or a negative potential).

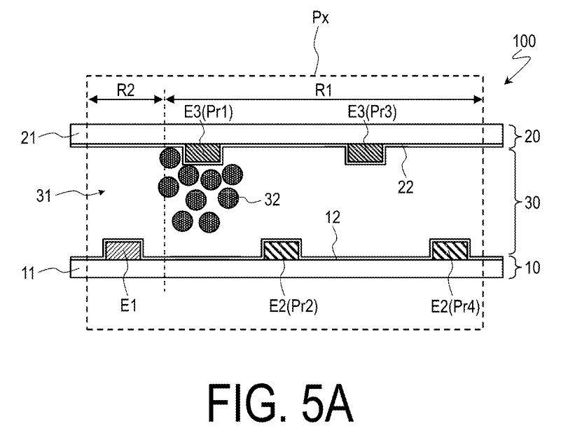

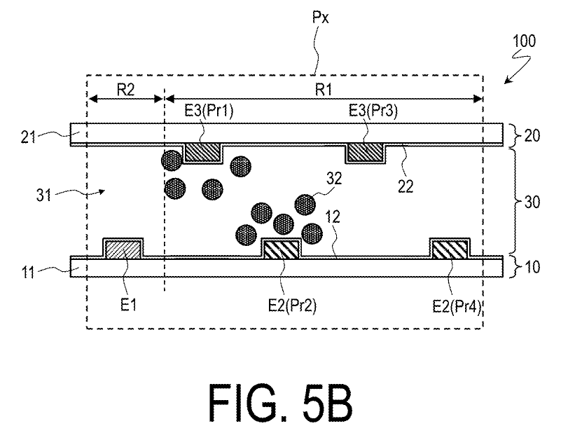

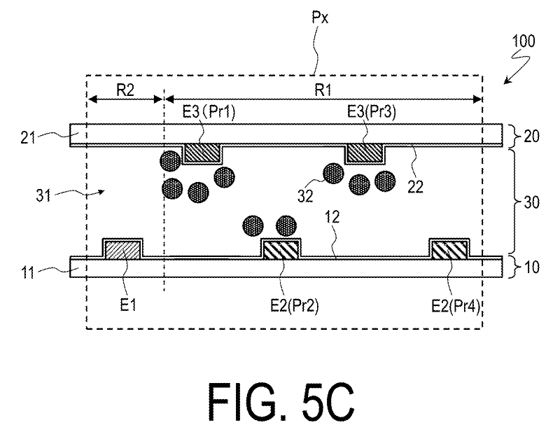

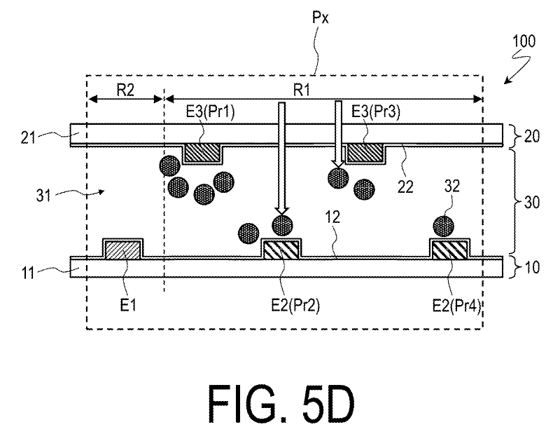

FIGS. 5A to 5D sequentially illustrate transition from the light transmitting state to the light blocking state described above (i.e., dispersion of the electrophoretic particles 32 within the opening region R1). In the following description, among the plurality of second electrodes E2 and the plurality of third electrodes E3, an electrode closest to the first electrode E1, an electrode second closest to the first electrode E1, an electrode third closest to the first electrode E1, and an electrode fourth closest to the first electrode E1 (i.e., an electrode farthest from the first electrode E1) are referred to as a first proximal electrode Pr1, a second proximal electrode Pr2, a third proximal electrode Pr3, and a fourth proximal electrode Pr4, respectively.

First, by applying a positive potential (a potential of the opposite polarity to that of the electrophoretic particles 32) to the third electrodes E3 and applying the ground potential (or a negative potential) to the second electrodes E2, the electrophoretic particles 32 are moved from near the first electrode E1 toward the first proximal electrode Pr1 (the third electrode E3 on a left side of the two third electrodes E3), as illustrated in FIG. 5A. At this time, the ground potential (0 V), for example, is applied to the first electrode E1.

Next, by applying the ground potential (or a negative potential) to the third electrodes E3 and applying a positive potential to the second electrodes E2, some of the electrophoretic particles 32 are moved from near the first proximal electrode Pr1 toward the second proximal electrode Pr2 (the second electrode E2 on a left side of the two second electrodes E2), as illustrated in FIG. 5B.

Subsequently, by applying a positive potential to the third electrodes E3 and applying the ground potential (or a negative potential) to the second electrodes E2, some of the electrophoretic particles 32 near the second proximal electrode Pr2are moved toward the third proximal electrode Pr3 (the third electrode E3 on a right side of the two third electrodes E3), as illustrated in FIG. 5C.

Thereafter, by applying the ground potential (or a negative potential) to the third electrodes E3 and applying a positive potential to the second electrodes E2, some of the electrophoretic particles 32 near the third proximal electrode Pr3 are moved toward the fourth proximal electrode Pr4 (the second electrode E2 on a right side of the two second electrodes E2), as illustrated in FIG. 5D.

In this manner, by sequentially attracting the electrophoretic particles 32 to the first proximal electrode Pr1, the second proximal electrode Pr2, the third proximal electrode Pr3, and the fourth proximal electrode Pr4, the light blocking state in which the electrophoretic particles 32 are positioned within the opening region R1 can be achieved.

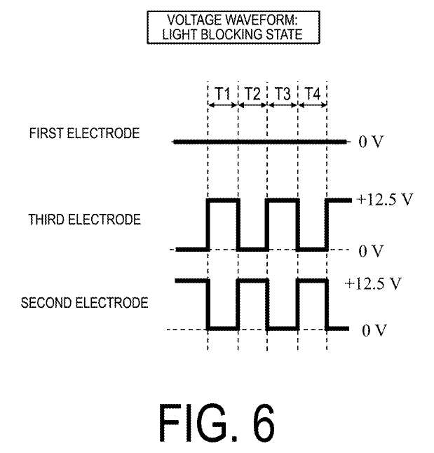

FIG. 6 illustrates an example of waveforms of voltages applied to the first electrode E1, the second electrodes E2, and the third electrodes E3, when achieving the light blocking state. In FIG. 6, an attraction period to the first proximal electrode Pr1 is denoted by T1, an attraction period to the second proximal electrode Pr2 is denoted by T2, an attraction period to the third proximal electrode Pr3 is denoted by T3, and an attraction period to the fourth proximal electrode Pr4 is denoted by T4.

In the example illustrated in FIG. 6, the voltage applied to the first electrode E1 is 0 V. The voltage applied to the third electrodes E3 is a DC voltage that changes from +12.5 V to 0 V, then to +12.5 V, and then to 0 V from a start of the period T1, and the voltage applied to the second electrodes E2 is a DC voltage that changes from 0 V to +12.5 V, then to 0 V, and then to +12.5 V from the start of the period T1. That is, DC voltages of opposite phases are applied to the plurality of second electrodes E2 and the plurality of third electrodes E3. A frequency of the DC voltage applied to the second electrodes E2 and the third electrodes E3 is, for example, 0.5 Hz.

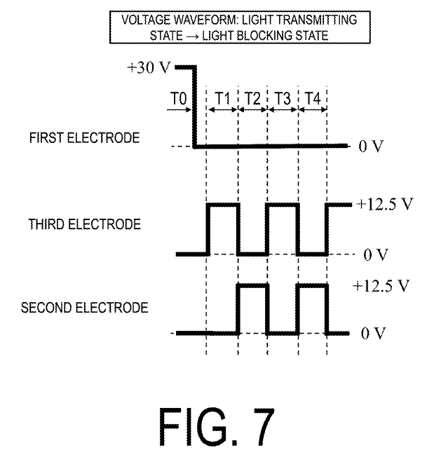

FIG. 7 illustrates another example of waveforms of voltages applied to the electrodes. In FIG. 7, a period during which the electrophoretic particles 32 are attracted to the first electrode E1 is denoted by T0. In the example illustrated in FIG. 7, first, a DC voltage of +30 V is applied to the first electrode E1 to attract the electrophoretic particles 32 within the opening region R1 to the first electrode E1 (initialization), and then DC voltages similar to those illustrated in FIG. 6 are applied to the second electrodes E2 and the third electrodes E3 to disperse the electrophoretic particles 32 into the opening region R1.

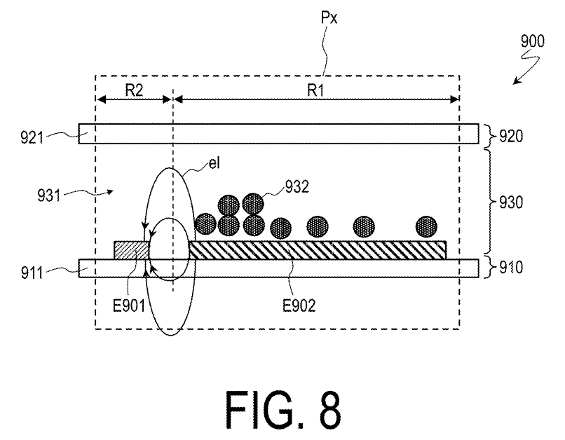

FIG. 8 illustrates an electrophoretic element 900 of a comparative example. As illustrated in FIG. 8, the electrophoretic element 900 of the comparative example includes a first substrate 910 and a second substrate 920 facing each other, and an electrophoretic layer 930 provided between the first substrate 910 and the second substrate 920. Each pixel Px of the electrophoretic element 900 includes an opening region R1 and a light blocking region R2.

The electrophoretic layer 930 contains, in each pixel Px, a dispersion medium 931 and a plurality of electrophoretic particles 932 dispersed in the dispersion medium 931. Here, the electrophoretic particles 932 are charged with a negative polarity.

The first substrate 910 includes a first electrode E901 and a second electrode E902 in each pixel Px. The first electrode E901 is located within the light blocking region R2. In contrast, the second electrode E902 is located within the opening region R1. The first electrode E901 and the second electrode E902 are supported by a transparent substrate 911.

The second substrate 920 includes a transparent substrate 921. The second substrate 920 does not include an electrode in each pixel Px.

The electrophoretic element 900 can switch between a light transmitting state and a light blocking state by controlling potentials of the first electrode E901 and the second electrode E902. To be specific, by applying a positive potential to the first electrode E901 and applying the ground potential (or a negative potential) to the second electrode E902, the electrophoretic particles 932 move toward the first electrode E901, thereby achieving the light transmitting state. Further, by applying a positive potential to the second electrode E902 and applying the ground potential (or a negative potential) to the first electrode E901, the electrophoretic particles 932 move toward the second electrode E902, as illustrated in FIG. 8, thereby achieving the light blocking state.

However, in the electrophoretic element 900 of the comparative example, the electrophoretic particles 932 tend to be dispersed non-uniformly within the opening region R1. This is due to a distribution of a transverse electrical field generated within the pixel Px. FIG. 8 illustrates lines of electric force el when a positive potential is applied to the second electrode E902 and a negative potential is applied to the first electrode E901. As can be seen from FIG. 8, in the electrophoretic element 900 of the comparative example, a strong electrical field is not easily formed in a region far from the first electrode E901 in the opening region R1, and thus it is difficult to uniformly disperse the electrophoretic particles 932 within the opening region R1.

In contrast, in the electrophoretic element 100 of the present embodiment, in each pixel Px, the first substrate 10 includes the plurality of second electrodes E2, and the second substrate 20 includes the plurality of third electrodes E3, and further, in a plan view, the second electrodes E2 and the third electrodes E3 are alternately arranged along the predetermined direction. Thus, as already described, the electrophoretic particles 32 can be attracted sequentially to the first proximal electrode Pr1, the second proximal electrode Pr2, the third proximal electrode Pr3, and the fourth proximal electrode Pr4, thereby enabling the electrophoretic particles 32 to be uniformly dispersed within the opening region R1.

Note that FIGS. 6 and 7 illustrate examples in which the same potential is applied to the plurality of second electrodes E2 and the same potential is applied to the plurality of third electrodes E3, but the mode of voltage application is not limited thereto. In each pixel Px, the plurality of second electrodes E2 may include two second electrodes E2 to which different potentials are applied, and the plurality of third electrodes E3 may include two third electrodes E3 to which different potentials are applied. In this case, in each pixel Px, the same potential may be applied to a certain second electrode E2 of the plurality of second electrodes E2 and a certain third electrode E3 of the plurality of third electrodes E3.

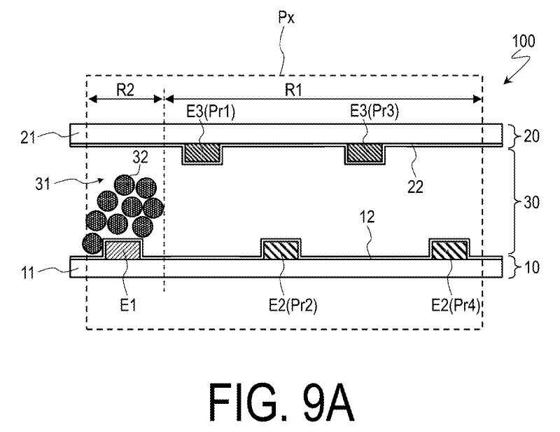

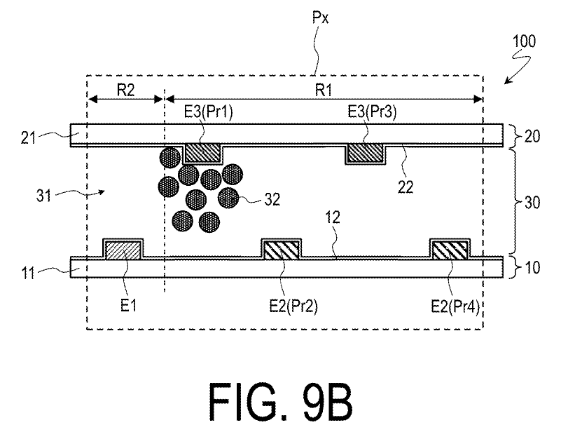

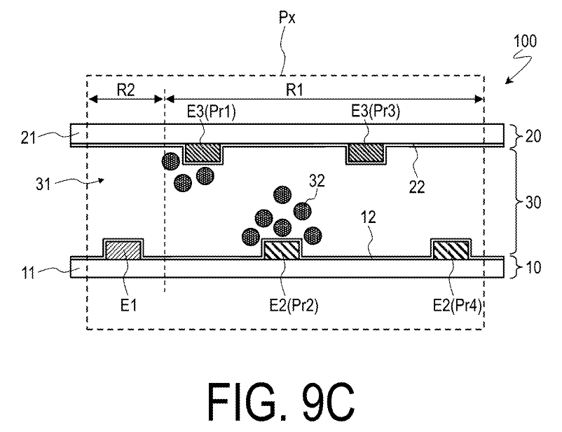

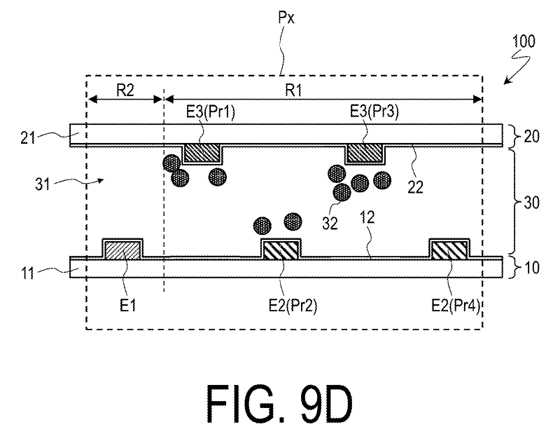

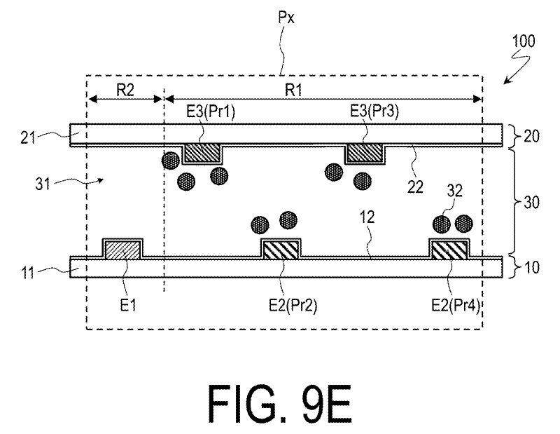

Another example of a voltage application mode will be described with reference to FIGS. 9A to 9E.

First, by applying a positive potential (a potential of the opposite polarity to that of the electrophoretic particles 32) to the first electrode E1, the electrophoretic particles 32 move toward the first electrode E1, thereby achieving the light transmitting state as illustrated in FIG. 9A. At this time, for example, the ground potential (0 V) is applied to the second electrodes E2 and the third electrodes E3.

Next, by applying a positive potential to the first proximal electrode Pr1 and applying the ground potential (or a negative potential) to the second proximal electrode Pr2 and the third proximal electrode Pr3, the electrophoretic particles 32 are moved from near the first electrode E1 toward the first proximal electrode Pr1, as illustrated in FIG. 9B. At this time, a positive potential, the ground potential, or a negative potential may be applied to the fourth proximal electrode Pr4. The ground potential (0 V), for example, is applied to the first electrode E1.

Subsequently, by applying a positive potential to the second proximal electrode Pr2 and applying the ground potential (or a negative potential) to the first proximal electrode Pr1, the third proximal electrode Pr3, and the fourth proximal electrode Pr4, some of the electrophoretic particles 32 are moved from near the first proximal electrode Pr1 toward the second proximal electrode Pr2, as illustrated in FIG. 9C.

Next, by applying a positive potential to the third proximal electrode Pr3 and applying the ground potential (or a negative potential) to the first proximal electrode Pr1, the second proximal electrode Pr2, and the fourth proximal electrode Pr4, some of the electrophoretic particles 32 near the second proximal electrode Pr2 are moved toward the third proximal electrode Pr3, as illustrated in FIG. 9D.

Thereafter, by applying a positive potential to the fourth proximal electrode Pr4 and applying the ground potential (or a negative potential) to the second proximal electrode Pr2 and the third proximal electrode Pr3, some of the electrophoretic particles 32 near the third proximal electrode Pr3 are moved toward the fourth proximal electrode Pr4, as illustrated in FIG. 9E. At this time, a positive potential, the ground potential, or a negative potential may be applied to the first proximal electrode Pr1.

In this manner, by sequentially attracting the electrophoretic particles 32 to the first proximal electrode Pr1, the second proximal electrode Pr2, the third proximal electrode Pr3, and the fourth proximal electrode Pr4, the light blocking state in which the electrophoretic particles 32 are positioned within the opening region R1 can be achieved.

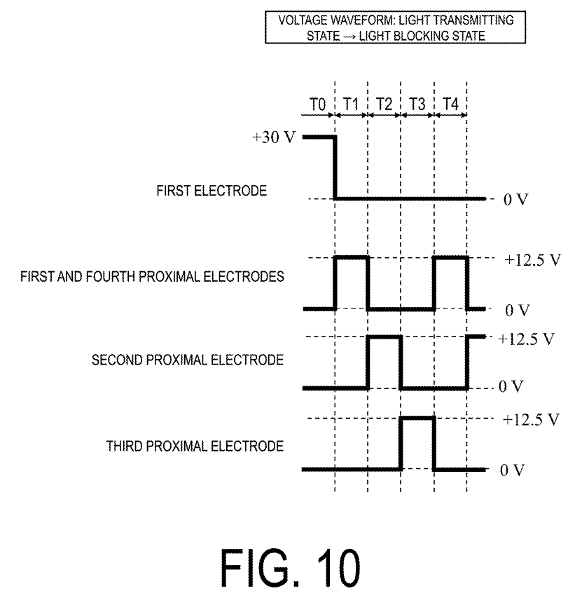

FIG. 10 illustrates an example of voltage waveforms used in the voltage application mode described with reference to FIGS. 9A to 9E.

In the example illustrated in FIG. 10, a DC voltage of +30 V is applied to the first electrode E1 during the period T0 in which the electrophoretic particles 32 are attracted to the first electrode E1, and the ground potential (0 V) (or a negative potential) is applied during the other periods T1, T2, T3, and T4. A DC voltage of +12.5 V is applied to the first proximal electrode Pr1 and the fourth proximal electrode Pr4 during the period T1 in which the electrophoretic particles 32 are attracted to the first proximal electrode Pr1 and the period T4 during which the electrophoretic particles 32 are attracted to the fourth proximal electrode Pr4, and a DC voltage of 0 V is applied to the other periods, T0, T2, and T3. A DC voltage of +12.5 V is applied to the second proximal electrode Pr2 during the period T2 in which the electrophoretic particles 32 are attracted to the second proximal electrode Pr2, and a DC voltage of 0 V is applied during the other periods T0, T1, T3, and T4. A DC voltage of +12.5 V is applied to the third proximal electrode Pr3 during the period T3 in which the electrophoretic particles 32 are attracted to the third proximal electrode Pr3, and a DC voltage of 0 V is applied during the other periods T0, T1, T2, and T4. A length of each of the periods T1, T2, T3, and T4 is, for example, 125 ms.

Here, of the positive polarity and the negative polarity, the polarity to which the electrophoretic particles 32 are charged is referred to as a "first polarity" and the polarity opposite to the first polarity is referred to as a "second polarity". In the mode described with reference to FIGS. 9A to 9E and 10, when transitioning the pixel Px from the light transmitting state to the light blocking state, DC voltages are applied to the plurality of second electrodes E2 and the plurality of third electrodes E3 so that the following states (1), (2), and (3) are formed sequentially.

(1) A state in which the first proximal electrode Pr1 is at the second polarity, and the second proximal electrode Pr2 and the third proximal electrode Pr3 are at the ground potential or the first polarity (FIG. 9B).

(2) A state in which the second proximal electrode Pr2 is at the second polarity, and the first proximal electrode Pr1 and the third proximal electrode Pr3 are at the ground potential or the first polarity (FIG. 9C).

(3) A state in which the third proximal electrode Pr3 is at the second polarity, and the first proximal electrode Pr1 and the second proximal electrode Pr2 are at the ground potential or the first polarity (FIG. 9D).

According to such a voltage application mode, the electrophoretic particles 32 can be dispersed more uniformly within the opening region R1. For example, during the period T3 in which the electrophoretic particles 32 are attracted to the third proximal electrode Pr3 (FIG. 9D), the first proximal electrode Pr1 is at the ground potential or the first polarity, so that movement of the electrophoretic particles 32 near the second proximal electrode Pr2 toward the first proximal electrode Pr1 can be suppressed.

Note that in the exemplified mode, after the state of (3) is formed, a state of (4) below is further formed.

(4) A state in which the fourth proximal electrode Pr4 is at the second polarity, and the second proximal electrode Pr2 and the third proximal electrode Pr3 are at the ground potential or the first polarity (FIG. 9E).

During the period T4 in which the electrophoretic particles 32 are attracted to the fourth proximal electrode Pr4 (FIG. 9E), the second proximal electrode Pr2 is at the ground potential or the first polarity, so that movement of the electrophoretic particles 32 near the third proximal electrode Pr3 toward the second proximal electrode Pr2 can be suppressed.

Thus, from the viewpoint of dispersing the electrophoretic particles 32 more uniformly, the mode described with reference to FIGS. 9A to 9E is preferable. On the other hand, by adopting the mode in which the same potential is applied to the plurality of second electrodes E2 and the same potential is applied to the plurality of third electrodes E3, as illustrated in FIGS. 6 and 7, an advantage of being able to reduce the number of types (systems) of signals used is obtained. Further, when adopting the mode illustrated in FIGS. 9A to 9E, the number of types (systems) of signals used can be similarly reduced by applying the same potential to the first proximal electrode Pr1 and the fourth proximal electrode Pr4 (i.e., applying the same potential to a certain second electrode E2 of the plurality of second electrodes E2 and a certain third electrode E3 of the plurality of third electrodes E3), as exemplified in FIG. 10.

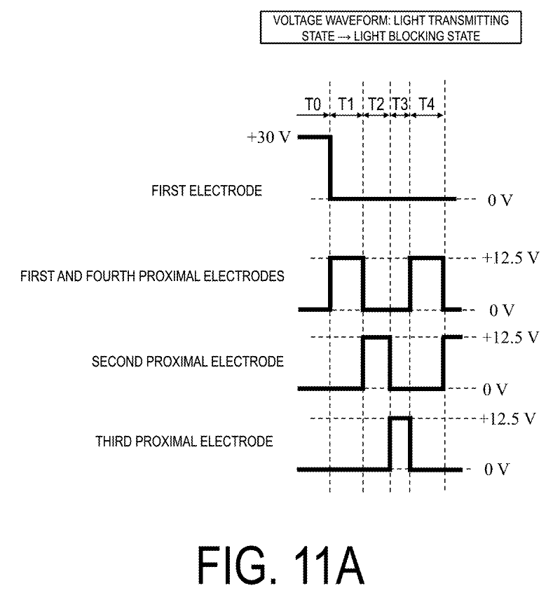

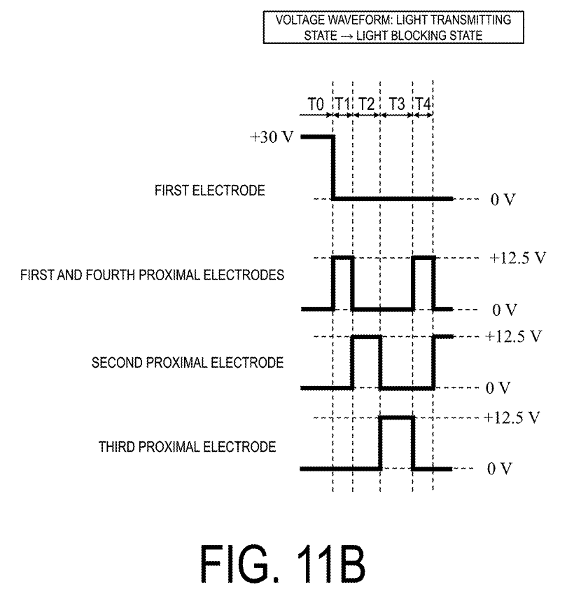

Note that FIG. 10 illustrates an example in which lengths of the periods T1, T2, T3, and T4 are all the same, but the lengths of the periods T1, T2, T3, and T4 do not need to be the same. FIGS. 11A and 11B illustrate another example and still another example of voltage waveforms.

Here, a length of a period T1, that is, a length of time during which the DC voltage of the second polarity is applied to the first proximal electrode Pr1, is denoted by t1. Similarly, when a length of a period T2, that is, a length of time during which the DC voltage of the second polarity is applied to the second proximal electrode Pr2 is denoted by t2, and a length of a period T3, that is, a length of time during which the DC voltage of the second polarity is applied to the third proximal electrode Pr3 is denoted by t3, in the example illustrated in FIG. 11A, the length t1 of the period T1, the length t2 of the period T2, and the length t3 of the period T3 satisfy a relationship t1 > t2 > t3. The length t1 of the period T1, the length t2 of the period T2, and the length t3 of the period T3 are, for example, 125 ms, 100 ms, and 75 ms, respectively. In the example illustrated in FIG. 11B, a length t1 of a period T1, a length t2 of a period T2, and a length t3 of a period T3 satisfy a relationship t1 < t2 < t3. The length t1 of the period T1, the length t2 of the period T2, and the length t3 of the period T3 are, for example, 75 ms, 100 ms, and 125 ms, respectively.

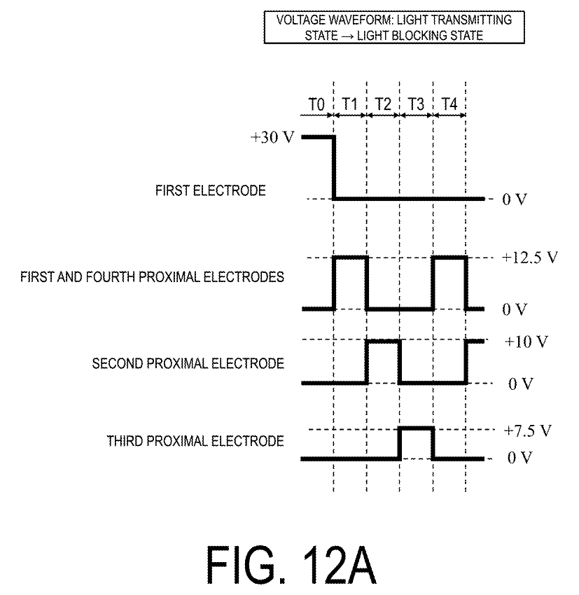

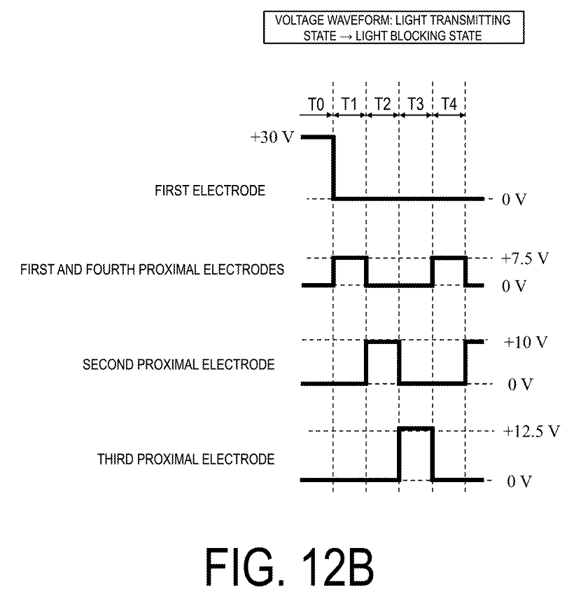

FIG. 10 illustrates an example in which magnitudes of the DC voltages of the second polarity applied to the first proximal electrode Pr1, the second proximal electrode Pr2, the third proximal electrode Pr3, and the fourth proximal electrode Pr4 are all the same, but they do not need to be the same. FIGS. 12A and 12B illustrate yet another example and a further example of voltage waveforms.

Here, when a magnitude of the DC voltage of the second polarity applied to the first proximal electrode Pr1 is denoted by V1, a magnitude of the DC voltage of the second polarity applied to the second proximal electrode Pr2 is denoted by V2, and a magnitude of the DC voltage of the second polarity applied to the third proximal electrode Pr3 is denoted by V3, in the example illustrated in FIG. 12A, a relationship V1 > V2 > V3 is satisfied. The magnitudes V1, V2, and V3 are, for example, +12.5 V, +10 V, and +7.5 V. In the example illustrated in FIG. 12B, a relationship V1 < V2 < V3 is satisfied. The magnitudes V1, V2, and V3 are, for example, +7.5 V, +10 V, and +12.5 V.

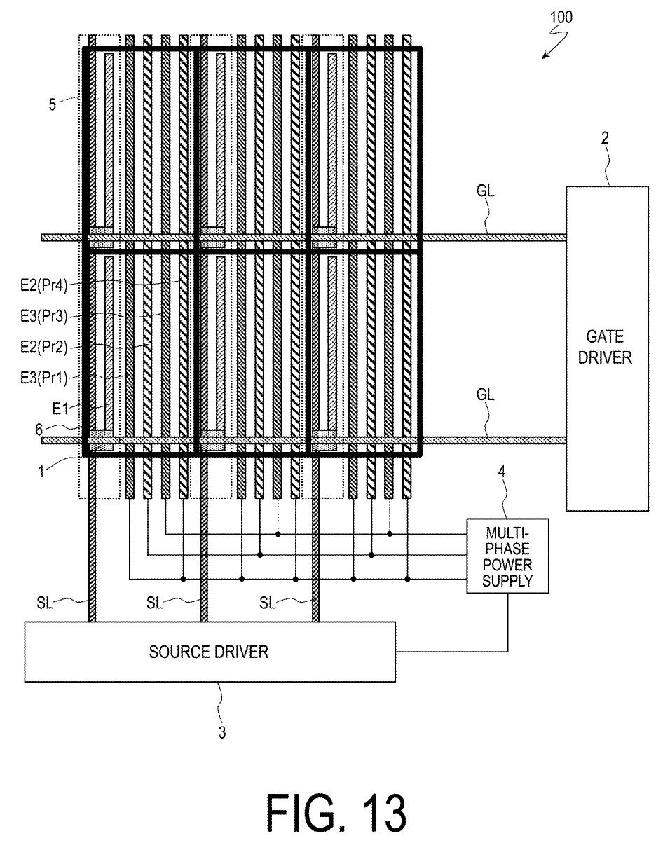

An example of a more specific configuration of the electrophoretic element 100 will be described with reference to FIG. 13. In the example illustrated in FIG. 13, the electrophoretic element 100 includes, in addition to the first electrodes E1 and the like already described, a plurality of thin film transistors (TFTs) 1, a plurality of gate wiring lines GL, and a plurality of source wiring lines SL. The electrophoretic element 100 further includes a gate driver (gate drive circuit) 2, a source driver (source drive circuit) 3, and a multi-phase power supply 4.

The plurality of gate wiring lines GL are arranged to extend in a row direction. Each gate wiring line GL supplies gate signals to the corresponding TFTs 1.

The plurality of source wiring lines SL are arranged to extend in a column direction. Each source wiring line SL supplies source signals to the corresponding TFTs 1.

Each of the plurality of TFTs 1 is provided corresponding to each pixel Px. A gate electrode of each TFT 1 is electrically connected to the corresponding gate wiring line GL. A source electrode of each TFT 1 is electrically connected to the corresponding source wiring line SL.

In the example illustrated in FIG. 13, the first electrode E1 is provided independently for each pixel Px, and a drain electrode of each TFT 1 is electrically connected to the corresponding first electrode E1. That is, the first electrode E1 of each pixel Px is electrically independent of the first electrodes E1 of the other pixels Px. A source signal supplied to the first electrode E1 via the TFT 1 corresponds to a voltage applied to the first electrode E1.

The gate driver 2 drives the gate wiring lines GL. The source driver 3 drives the source wiring lines SL.

In the example illustrated in FIG. 13, each second electrode E2 is a common electrode that extends across all pixel rows along the column direction and to which a common potential is applied across an entire one pixel column. Similarly, each third electrode E3 is a common electrode that extends across all pixel rows along the column direction and to which a common potential is applied across the entire one pixel column.

The second electrodes E2 and the third electrodes E3 are electrically connected to the multi-phase power supply 4, and are supplied with DC voltages from the multi-phase power supply 4. Although FIG. 13 illustrates an example in which the same voltage is supplied to the first proximal electrode Pr1 and the fourth proximal electrode Pr4, different voltages may be supplied to the first proximal electrode Pr1 and the fourth proximal electrode Pr4. In the example illustrated in FIG. 13, the source driver 3 is supplied with a DC voltage (source signal) to be supplied to the source wiring lines SL from the multi-phase power supply 4.

A light blocking layer (black matrix) 5 is provided so as to cover the TFTs 1, the source wiring lines SL, the first electrodes E1, and the like, and the light blocking region R2 is defined by the light blocking layer 5. A material of the light blocking layer 5 is, for example, a black resin material or a metal material having low reflectivity.

Between the first substrate 10 and the second substrate 20, a partition 6 is provided to separate the electrophoretic layer 30 into the pixels Px. The partition 6 is formed of, for example, a photoresist. A height of the partition 6 is the same as the thickness of the electrophoretic layer 30 (e.g., 15 μm), and a width of the partition 6 is, for example, about 5 μm. Dimensions of the pixel Px defined by the partition 6 (a length along the row direction and a length along the column direction) are, for example, about several hundred μm. The partition 6 prevents migration of the electrophoretic particles 32.

The dispersion medium 31 is an insulating colorless transparent liquid. Examples of the dispersion medium 31 that can be used include hydrocarbon-based solvents, such as isoparaffin, toluene, xylene, Norman paraffin, and silicone oil.

The electrophoretic particles 32 may be pigment particles of a desired color or resin particles containing a pigment or dye of a desired color. Examples of pigments and dyes that can be used include common pigments and dyes used in printing inks and color toners. Threshold characteristics (applied voltage required for movement) of the electrophoretic particles 32 can be determined by adjusting a charge amount, a particle diameter, a particle surface shape, a material, and the like.

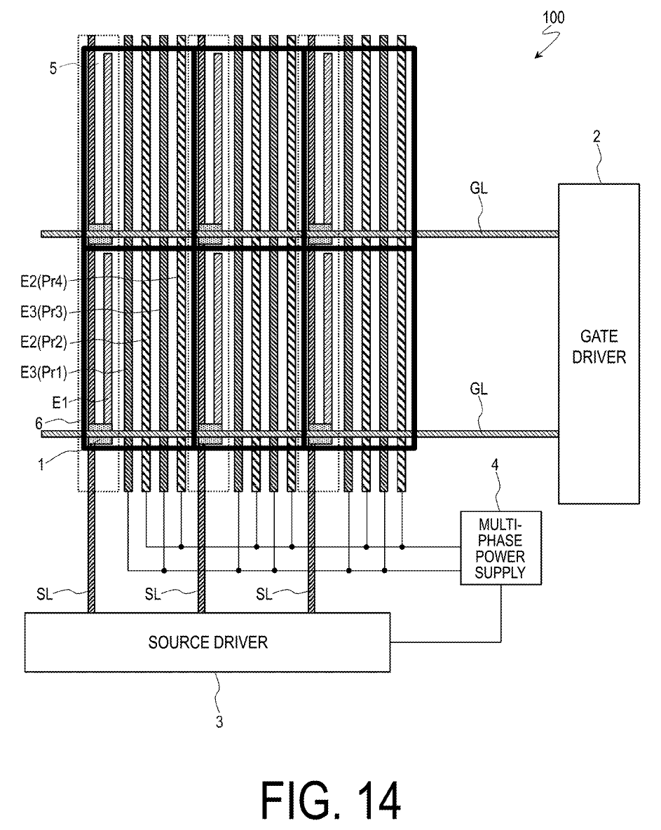

Note that a connection mode of the first proximal electrode Pr1, the second proximal electrode Pr2, the third proximal electrode Pr3, and the fourth proximal electrode Pr4 to the multi-phase power supply 4 is not limited to the example illustrated in FIG. 13. FIG. 14 illustrates another example of a connection mode to the multi-phase power supply 4. In the example illustrated in FIG. 14, the same voltage is supplied to the first proximal electrode Pr1 and the third proximal electrode Pr3, and the same voltage is supplied to the second proximal electrode Pr2 and the fourth proximal electrode Pr4.

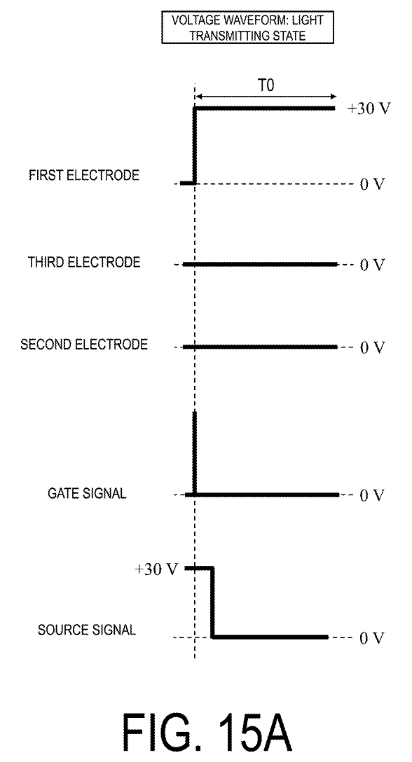

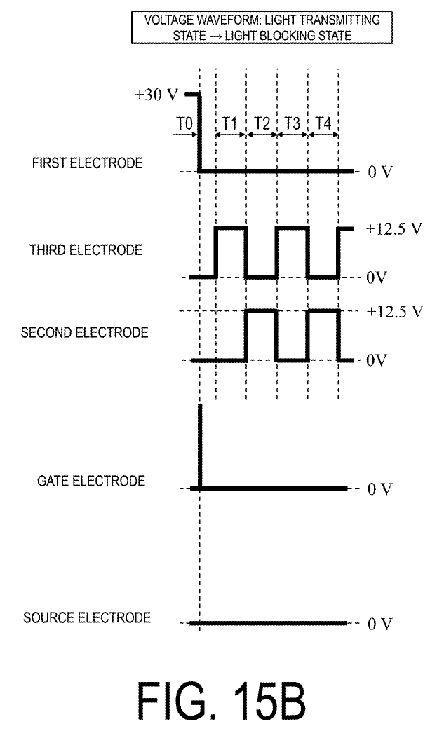

FIG. 15A illustrates an example of waveforms of a gate signal and a source signal when achieving the light transmitting state. As illustrated in FIG. 15A, the gate signal temporarily becomes high at a start of the period T0, thereby turning the TFT 1 on. The source signal is +30 V before the start of the period T0, and after the TFT 1 turns on at the start of the period T0 and the source signal is applied to the first electrode E1 (i.e., written to the pixel Px), the source signal becomes 0 V. When the source signal becomes 0 V, the gate signal is already at a low level and the TFT 1 is in an off state, so the source signal applied to the first electrode E1 is maintained as it is.

FIG. 15B illustrates an example of waveforms of the gate signal and the source signal when transitioning from the light transmitting state to the light blocking state. As illustrated in FIG. 15B, the gate signal temporarily becomes high at an end of the period T0, thereby turning the TFT 1 on. The source signal is 0 V before the end of the period T0, and after the TFT 1 turns on at the end of the period T0 and the source signal is applied to the first electrode E1 (i.e., written to the pixel Px), the source signal remains at 0 V. When the gate signal becomes a low level, the TFT 1 turns off, so the source signal applied to the first electrode E1 is maintained as it is.

### Second Embodiment

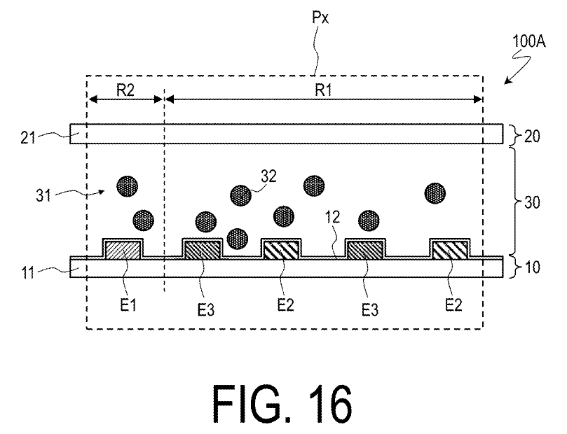

An electrophoretic element 100A according to a present embodiment will be described with reference to FIG. 16. FIG. 16 is a cross-sectional view schematically illustrating the electrophoretic element 100A, illustrating a region corresponding to one pixel Px of the electrophoretic element 100A. The electrophoretic element 100A according to the present embodiment is suitably used as a light shutter panel, similar to the electrophoretic element 100 according to the first embodiment. The following description will focus on differences between the electrophoretic element 100A and the electrophoretic element 100 of the first embodiment.

The electrophoretic element 100A differs from the electrophoretic element 100 of the first embodiment in that a first substrate 10 includes a plurality of third electrodes E3. That is, in the electrophoretic element 100A, the first substrate 10 includes both the second electrodes E2 and the third electrodes E3.

The plurality of third electrodes E3 are provided on an electrophoretic layer 30 side of a transparent substrate 11, and are supported by the transparent substrate 11, together with a first electrode E1 and the plurality of second electrodes E2. The plurality of third electrodes E3 are covered with a first surface modification layer 12 together with the first electrode E1 and the plurality of second electrodes E2.

A second substrate 20 does not include the second electrodes E2 or the third electrodes E3, and does not include a surface modification layer.

In the present embodiment, in a plan view, one of the plurality of second electrodes E2 and one of the plurality of third electrodes E3 are alternately arranged along a predetermined direction. In the illustrated example, the third electrode E3, the second electrode E2, the third electrode E3, and the second electrode E2 are arranged in this order along a direction from a left side to a right side in the figure. In each pixel Px, the plurality of second electrodes E2 and the plurality of third electrodes E3 do not overlap each other in a plan view.

Next, the operation of the electrophoretic element 100A will be described.

The electrophoretic element 100A, similar to the electrophoretic element 100 of the first embodiment, can switch the pixel Px between a light transmitting state and a light blocking state by controlling potentials of the first electrode E1, the plurality of second electrodes E2, and the plurality of third electrodes E3.

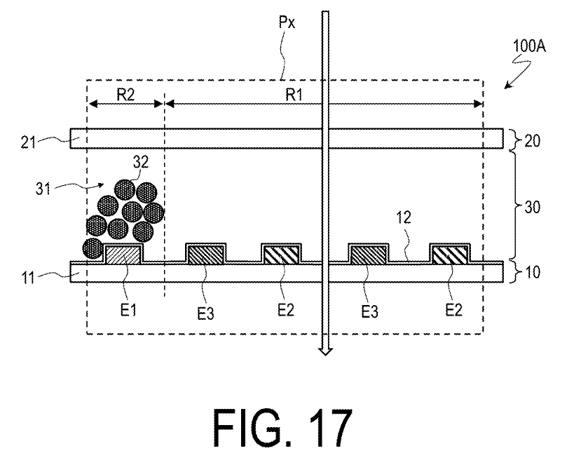

FIG. 17 illustrates the light transmitting state. By applying a potential of an opposite polarity to that of the electrophoretic particles 32 (here, a positive potential) to the first electrode E1, the electrophoretic particles 32 move toward the first electrode E1. Thus, as illustrated in FIG. 17, the light transmitting state can be achieved in which the electrophoretic particles 32 are not located within the opening region R1 (i.e., are located near the first electrode E1 within the light blocking region R2). At this time, for example, a ground potential (0 V) is applied to the second electrodes E2 and the third electrodes E3.

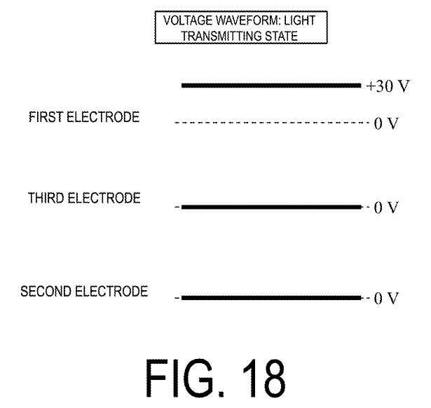

FIG. 18 illustrates an example of waveforms of voltages applied to the first electrode E1, the second electrodes E2, and the third electrodes E3, when achieving the light transmitting state. In the example illustrated in FIG. 18, the voltage applied to the first electrode E1 is a DC voltage of +30 V, and the voltage applied to the second electrodes E2 and the third electrodes E3 is 0 V (or a negative potential).

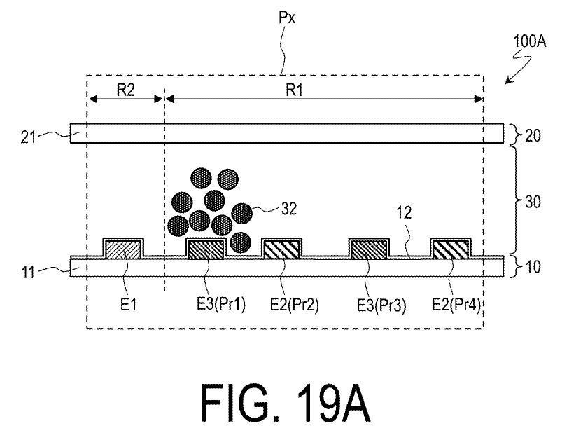

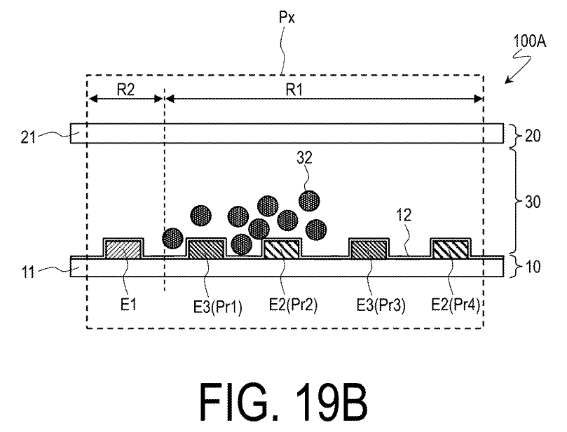

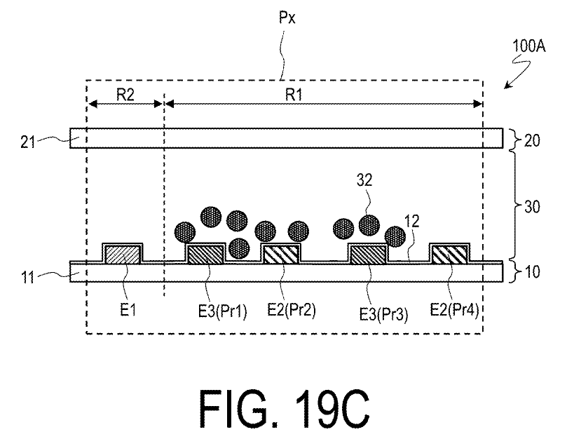

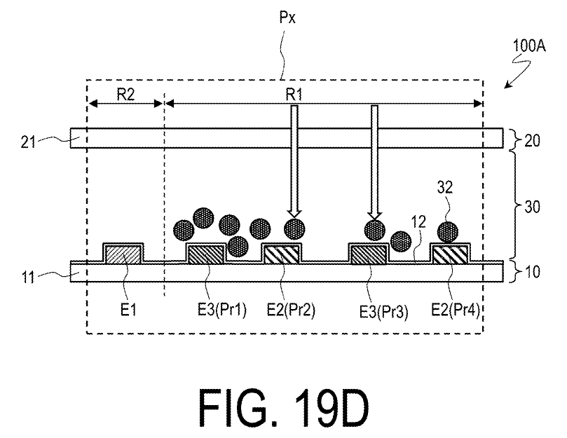

FIGS. 19A to 19D sequentially illustrate transition from the light transmitting state to the light blocking state described above (i.e., dispersion of the electrophoretic particles 32 within the opening region R1). In the following description as well, among the plurality of second electrodes E2 and the plurality of third electrodes E3, an electrode closest to the first electrode E1, an electrode second closest to the first electrode E1, an electrode third closest to the first electrode E1, and an electrode fourth closest to the first electrode E1 (i.e., an electrode farthest from the first electrode E1) are referred to as a first proximal electrode Pr1, a second proximal electrode Pr2, a third proximal electrode Pr3, and a fourth proximal electrode Pr4, respectively.

First, by applying a positive potential (a potential of the opposite polarity to that of the electrophoretic particles 32) to the third electrodes E3, and applying the ground potential (or a negative potential) to the second electrodes E2, the electrophoretic particles 32 are moved from near the first electrode E1 toward the first proximal electrode Pr1 (the third electrode E3 on a left side of the two third electrodes E3), as illustrated in FIG. 19A. At this time, the ground potential (0 V), for example, is applied to the first electrode E1.

Next, by applying the ground potential (or a negative potential) to the third electrodes E3 and applying a positive potential to the second electrodes E2, some of the electrophoretic particles 32 are moved from near the first proximal electrode Pr1 toward the second proximal electrode Pr2 (the second electrode E2 on a left side of the two second electrodes E2), as illustrated in FIG. 19B.

Subsequently, by applying a positive potential to the third electrodes E3 and applying the ground potential (or a negative potential) to the second electrodes E2, some of the electrophoretic particles 32 near the second proximal electrode Pr2 are moved toward the third proximal electrode Pr3 (the third electrode E3 on a right side of the two third electrodes E3), as illustrated in FIG. 19C.

Thereafter, by applying the ground potential (or a negative potential) to the third electrodes E3 and applying a positive potential to the second electrodes E2, some of the electrophoretic particles 32 near the third proximal electrode Pr3 are moved toward the fourth proximal electrode Pr4 (the second electrode E2 on a right side of the two second electrodes E2), as illustrated in FIG. 19D.

In this manner, by sequentially attracting the electrophoretic particles 32 to the first proximal electrode Pr1, the second proximal electrode Pr2, the third proximal electrode Pr3, and the fourth proximal electrode Pr4, the light blocking state in which the electrophoretic particles 32 are positioned within the opening region R1 can be achieved.

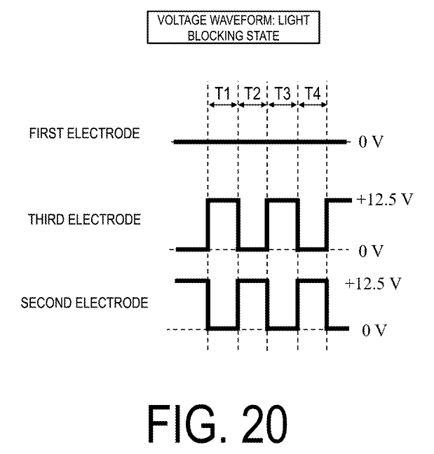

FIG. 20 illustrates an example of waveforms of voltages applied to the first electrode E1, the second electrodes E2, and the third electrodes E3, when achieving the light blocking state. In FIG. 20, an attraction period to the first proximal electrode Pr1 is denoted by T1, an attraction period to the second proximal electrode Pr2 is denoted by T2, an attraction period to the third proximal electrode Pr3 is denoted by T3, and an attraction period to the fourth proximal electrode Pr4 is denoted by T4.

In the example illustrated in FIG. 20, the voltage applied to the first electrode E1 is 0 V. The voltage applied to the third electrodes E3 is a DC voltage that changes from +12.5 V to 0 V, then to +12.5 V, and then to 0 V from a start of the period T1, and the voltage applied to the second electrodes E2 is a DC voltage that changes from 0 V to +12.5 V, then to 0 V, and then to +12.5 V from the start of the period T1. That is, DC voltages of opposite phases are applied to the plurality of second electrodes E2 and the plurality of third electrodes E3. A frequency of the DC voltage applied to the second electrodes E2 and the third electrodes E3 is, for example, 0.5 Hz.

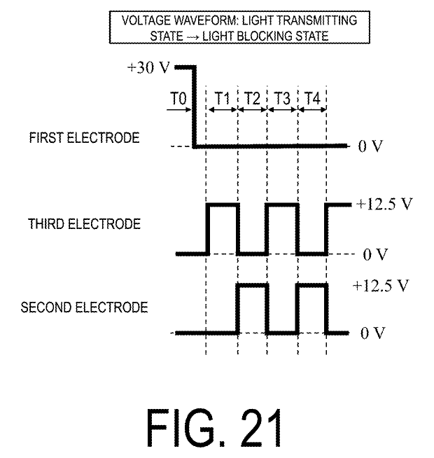

FIG. 21 illustrates another example of waveforms of voltages applied to the electrodes. In FIG. 21, a period during which the electrophoretic particles 32 are attracted to the first electrode E1 is denoted by T0. In the example illustrated in FIG. 21, first, a DC voltage of +30 V is applied to the first electrode E1 to attract the electrophoretic particles 32 within the opening region R1 to the first electrode E1 (initialization), and then DC voltages similar to those illustrated in FIG. 20 are applied to the second electrodes E2 and the third electrodes E3 to disperse the electrophoretic particles 32 into the opening region R1.

Thus, in the electrophoretic element 100A of the present embodiment as well, the electrophoretic particles 32 can be sequentially attracted to the first proximal electrode Pr1, the second proximal electrode Pr2, the third proximal electrode Pr3, and the fourth proximal electrode Pr4, thereby enabling the electrophoretic particles 32 to be uniformly dispersed within the opening region R1.

Note that FIGS. 20 and 21 illustrate examples in which the same potential is applied to the plurality of second electrodes E2 and the same potential is applied to the plurality of third electrodes E3, but the mode of voltage application is not limited thereto. In each pixel Px, the plurality of second electrodes E2 may include two second electrodes E2 to which different potentials are applied, and the plurality of third electrodes E3 may include two third electrodes E3 to which different potentials are applied. In this case, in each pixel Px, the same potential may be applied to a certain second electrode E2 of the plurality of second electrodes E2 and a certain third electrode E3 of the plurality of third electrodes E3.

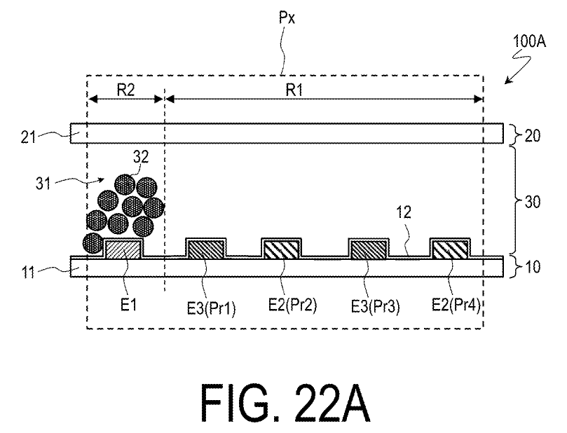

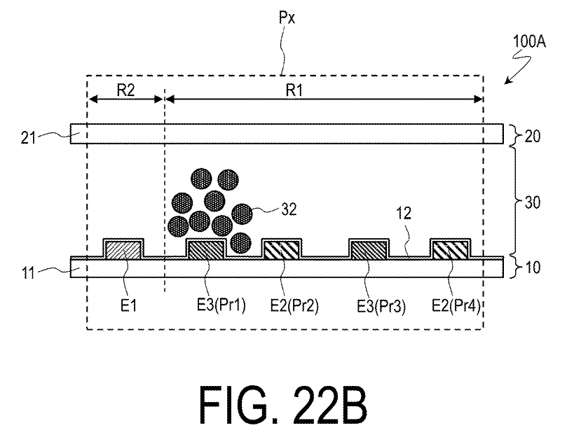

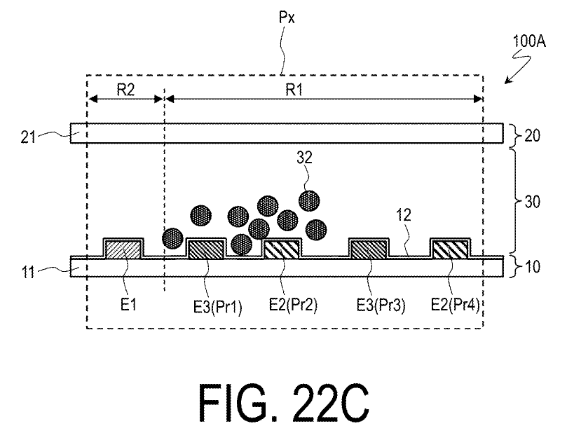

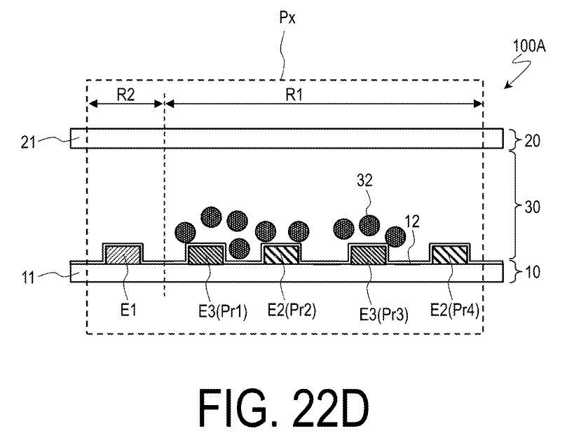

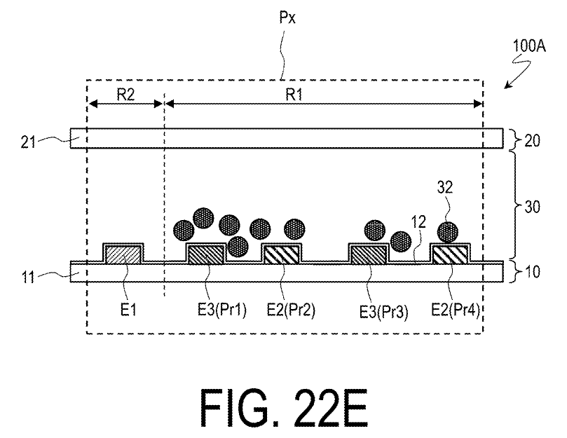

Another example of a voltage application mode will be described with reference to FIGS. 22A to 22E.

First, by applying a positive potential (a potential of the opposite polarity to that of the electrophoretic particles 32) to the first electrode E1, the electrophoretic particles 32 move toward the first electrode E1, thereby achieving the light transmitting state as illustrated in FIG. 22A. At this time, for example, the ground potential (0 V) is applied to the second electrodes E2 and the third electrodes E3.

Next, by applying a positive potential to the first proximal electrode Pr1 and applying the ground potential (or a negative potential) to the second proximal electrode Pr2 and the third proximal electrode Pr3, the electrophoretic particles 32 are moved from near the first electrode E1 toward the first proximal electrode Pr1, as illustrated in FIG. 22B. At this time, a positive potential, the ground potential, or a negative potential may be applied to the fourth proximal electrode Pr4. The ground potential (0 V), for example, is applied to the first electrode E1.

Subsequently, by applying a positive potential to the second proximal electrode Pr2 and applying the ground potential (or a negative potential) to the first proximal electrode Pr1, the third proximal electrode Pr3, and the fourth proximal electrode Pr4, some of the electrophoretic particles 32 are moved from near the first proximal electrode Pr1 toward the second proximal electrode Pr2, as illustrated in FIG. 22C.

Next, by applying a positive potential to the third proximal electrode Pr3 and applying the ground potential (or a negative potential) to the first proximal electrode Pr1, the second proximal electrode Pr2, and the fourth proximal electrode Pr4, some of the electrophoretic particles 32 near the second proximal electrode Pr2 are moved toward the third proximal electrode Pr3, as illustrated in FIG. 22D.

Thereafter, by applying a positive potential to the fourth proximal electrode Pr4 and applying the ground potential (or a negative potential) to the second proximal electrode Pr2 and the third proximal electrode Pr3, some of the electrophoretic particles 32 near the third proximal electrode Pr3 are moved toward the fourth proximal electrode Pr4, as illustrated in FIG. 22E. At this time, a positive potential, the ground potential, or a negative potential may be applied to the first proximal electrode Pr1.

In this manner, by sequentially attracting the electrophoretic particles 32 to the first proximal electrode Pr1, the second proximal electrode Pr2, the third proximal electrode Pr3, and the fourth proximal electrode Pr4, the light blocking state in which the electrophoretic particles 32 are positioned within the opening region R1 can be achieved.

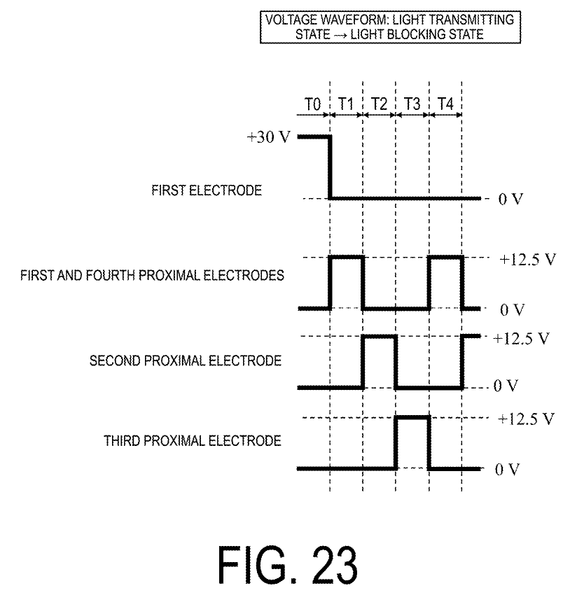

FIG. 23 illustrates an example of voltage waveforms used in the voltage application mode described with reference to FIGS. 22A to 22E.

In the example illustrated in FIG. 23, a DC voltage of +30 V is applied to the first electrode E1 during the period T0 in which the electrophoretic particles 32 are attracted to the first electrode E1, and the ground potential (0 V) (or a negative potential) is applied during the other periods T1, T2, T3, and T4. A DC voltage of +12.5 V is applied to the first proximal electrode Pr1 and the fourth proximal electrode Pr4 during the period T1 in which the electrophoretic particles 32 are attracted to the first proximal electrode Pr1 and the period T4 during which the electrophoretic particles 32 are attracted to the fourth proximal electrode Pr4, and a DC voltage of 0 V is applied to the other periods, T0, T2, and T3. A DC voltage of +12.5 V is applied to the second proximal electrode Pr2 during the period T2 in which the electrophoretic particles 32 are attracted to the second proximal electrode Pr2, and a DC voltage of 0 V is applied during the other periods T0, T1, T3, and T4. A DC voltage of +12.5 V is applied to the third proximal electrode Pr3 during the period T3 in which the electrophoretic particles 32 are attracted to the third proximal electrode Pr3, and a DC voltage of 0 V is applied during the other periods T0, T1, T2, and T4. A length of each of the periods T1, T2, T3, and T4 is, for example, 125 ms.

Here, of the positive polarity and the negative polarity, the polarity to which the electrophoretic particles 32 are charged is referred to as a "first polarity" and the polarity opposite to the first polarity is referred to as a "second polarity". In the mode described with reference to FIGS. 22A to 22E and 23, when transitioning the pixel Px from the light transmitting state to the light blocking state, DC voltages are applied to the plurality of second electrodes E2 and the plurality of third electrodes E3 so that the following states (1), (2), and (3) are formed sequentially.
(1) A state in which the first proximal electrode Pr1 is at the second polarity, and the second proximal electrode Pr2 and the third proximal electrode Pr3 are at the ground potential or the first polarity (FIG. 22B).
(2) A state in which the second proximal electrode Pr2 is at the second polarity, and the first proximal electrode Pr1 and the third proximal electrode Pr3 are at the ground potential or the first polarity (FIG. 22C).
(3) A state in which the third proximal electrode Pr3 is at the second polarity, and the first proximal electrode Pr1 and the second proximal electrode Pr2 are at the ground potential or the first polarity (FIG. 22D).

According to such a voltage application mode, the electrophoretic particles 32 can be dispersed more uniformly within the opening region R1. For example, during the period T3 in which the electrophoretic particles 32 are attracted to the third proximal electrode Pr3 (FIG. 22D), the first proximal electrode Pr1 is at the ground potential or the first polarity, so that movement of the electrophoretic particles 32 near the second proximal electrode Pr2 toward the first proximal electrode Pr1 can be suppressed.

Note that in the exemplified mode, after the state of (3) is formed, a state of (4) below is further formed.

(4) A state in which the fourth proximal electrode Pr4 is at the second polarity, and the second proximal electrode Pr2 and the third proximal electrode Pr3 are at the ground potential or the first polarity (FIG. 22E).

During the period T4 in which the electrophoretic particles 32 are attracted to the fourth proximal electrode Pr4 (FIG. 22E), the second proximal electrode Pr2 is at the ground potential or the first polarity, so that movement of the electrophoretic particles 32 near the third proximal electrode Pr3 toward the second proximal electrode Pr2 can be suppressed.

Thus, from the viewpoint of dispersing the electrophoretic particles 32 more uniformly, the mode described with reference to FIGS. 22A to 22E is preferable. On the other hand, by adopting the mode in which the same potential is applied to the plurality of second electrodes E2 and the same potential is applied to the plurality of third electrodes E3, as illustrated in FIGS. 20 and 21, an advantage of being able to reduce the number of types (systems) of signals used is obtained. Further, when adopting the mode illustrated in FIGS. 22A to 22E, the number of types (systems) of signals used can be similarly reduced by applying the same potential to the first proximal electrode Pr1 and the fourth proximal electrode Pr4 (i.e., applying the same potential to a certain second electrode E2 of the plurality of second electrodes E2 and a certain third electrode E3 of the plurality of third electrodes E3), as exemplified in FIG. 23.

Note that FIG. 23 illustrates an example in which lengths of the periods T1, T2, T3, and T4 are all the same, but the lengths of the periods T1, T2, T3, and T4 do not need to be the same. For example, a length t1 of the period T1, a length t2 of the period T2, and a length t3 of the period T3 may satisfy a relationship t1 > t2 > t3 or may satisfy a relationship t1 < t2 < t3.

FIG. 23 illustrates an example in which magnitudes of the DC voltages of the second polarity applied to the first proximal electrode Pr1, the second proximal electrode Pr2, the third proximal electrode Pr3, and the fourth proximal electrode Pr4 are all the same, but they do not need to be the same. For example, a magnitude V1 of the DC voltage of the second polarity applied to the first proximal electrode Pr1, a magnitude V2 of the DC voltage of the second polarity applied to the second proximal electrode Pr2, and a magnitude V3 of the DC voltage of the second polarity applied to the third proximal electrode Pr3 may satisfy a relationship V1 > V2 > V3 or may satisfy a relationship V1 < V2 < V3.

Note that a configuration in which the first substrate 10 includes both the second electrodes E2 and the third electrodes E3 is exemplified here, but a configuration in which the second substrate 20 includes both the second electrodes E2 and the third electrodes E3 may be adopted. The configuration in which one of the first substrate 10 and the second substrate 20 includes both the second electrodes E2 and the third electrodes E3 has an advantage of easy manufacturing, in that a circuit is formed on only one substrate. In contrast, a configuration such as the electrophoretic element 100 of the first embodiment, in which the first substrate 10 includes the second electrodes E2 and the second substrate 20 includes the third electrodes E3, has an advantage that the electrophoretic particles 32 move more readily because an electrical field is applied obliquely.

Note that in the electrophoretic element 100 of the first embodiment and the electrophoretic element 100A of the second embodiment, in addition to the first electrode E1, an electrode to which the same potential as that of the second electrodes E2 is applied and/or an electrode to which the same potential as that of the third electrodes E3 is applied may be provided in the light blocking region R2.

### Display Device Including Electrophoretic Element

As already described, the electrophoretic elements 100 and 100A are suitable for use as light shutter panels. Here, an example of a transparent display (display device) that includes the electrophoretic element 100 (or 100A) as a light shutter panel will be described.

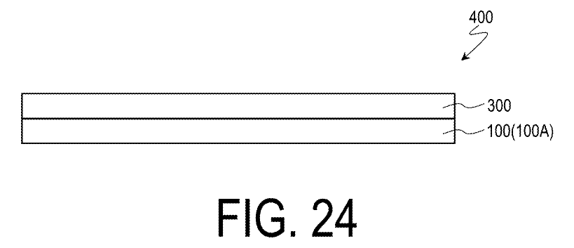

FIG. 24 is a diagram schematically illustrating a display device (transparent display) 400. As illustrated in FIG. 24, the display device 400 includes a display panel 300 and the electrophoretic element (light shutter panel) 100 (or 100A).

The display panel 300 is a self-luminous type. The self-luminous display panel 300 may be, for example, an OLED display panel, a μLED display panel, a QD-LED display panel, or a nanoLED display panel.

The electrophoretic element 100 (or 100A) is positioned so as to overlap the display panel 300. The electrophoretic element 100 (or 100A) is positioned on a back side of the display panel 300 (a side opposite to a viewer side).

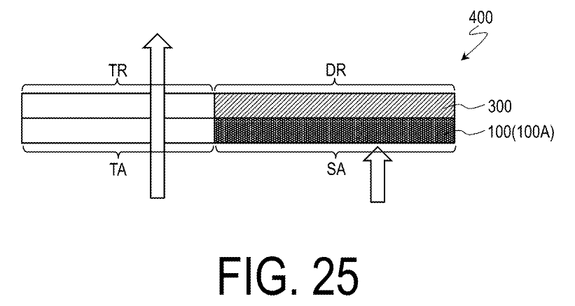

FIG. 25 illustrates a state in which an image is displayed on a portion of a displayable region of the display panel 300 (hereinafter referred to as an "image display region") DR, and no image is displayed in another region (hereinafter referred to as a "transparent region") TR. In this state, the pixels Px in a region SA of the electrophoretic element 100 (or 100A) that overlaps the image display region DR of the display panel 300 in a plan view are set to a light blocking state, and the pixels Px in a region TA of the electrophoretic element 100 (or 100A) that overlaps the transparent region TR of the display panel 300 in a plan view are set to the light transmitting state, thereby suppressing display distortion and a decrease in contrast ratio in the image display region DR while maintaining transparency of the transparent region TR.

### Applications Other than Light Shutter Panel

The electrophoretic elements according to the embodiments of the disclosure may be used for applications other than the light shutter panels. For example, the electrophoretic elements according to the embodiments of the disclosure may be reflective display devices. When the electrophoretic element is used as a reflective display device, a light reflective layer or a light absorption layer may be placed on a back side of an electrophoretic layer.

### Third Embodiment

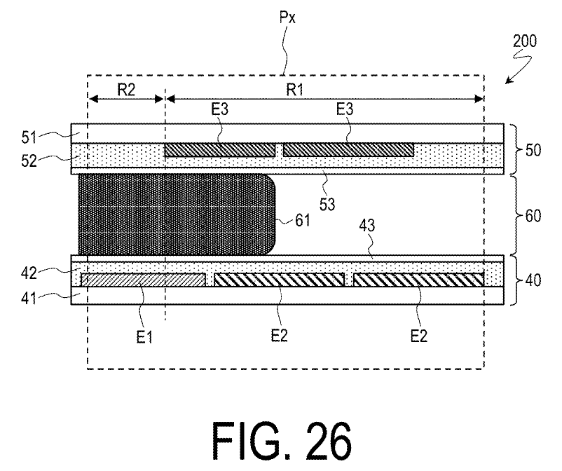

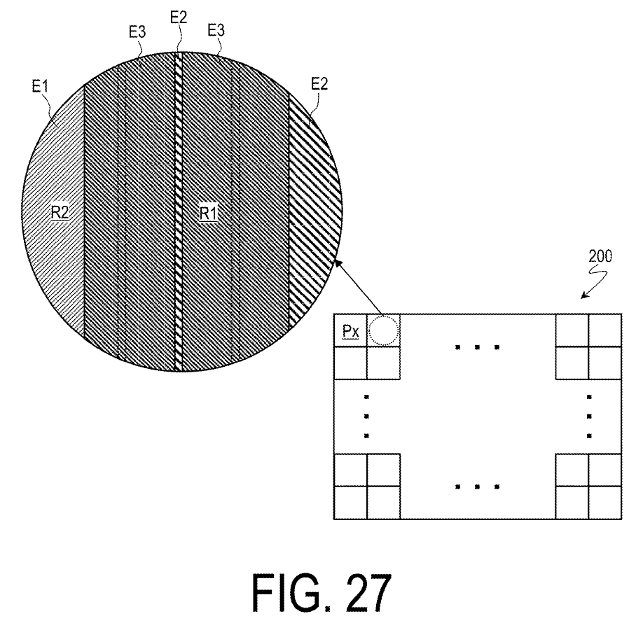

An electrowetting element 200 according to the present embodiment will be described with reference to FIGS. 26 and 27. FIGS. 26 and 27 are a cross-sectional view and a plan view, respectively, schematically illustrating the electrowetting element 200. FIG. 26 illustrates a region corresponding to one pixel Px of the electrowetting element 200. The electrowetting element 200 according to the present embodiment is suitably used as, for example, a light shutter panel.

As illustrated in FIG. 26, the electrowetting element 200 includes a first substrate 40 and a second substrate 50 placed to face the first substrate 40 with a space 60 interposed therebetween. Here, a lower side in FIG. 26 is a front side of the electrowetting element 200, and an upper side in FIG. 26 is a back side of the electrowetting element 200. That is, the first substrate 40 is positioned on the front side, and the second substrate 50 is positioned on the back side.

The electrowetting element 200 has a plurality of pixels Px, as illustrated in FIG. 27. The plurality of pixels Px are arrayed in a matrix including a plurality of rows and a plurality of columns. Each of the plurality of pixels Px includes an opening region R1. The opening region R1 is a region through which light passes from the space 60 to the front side. In each pixel Px, a region (light blocking region) R2 other than the opening region R1 is provided with a light blocking layer (not illustrated here) positioned on the front side of the space 60.

In each pixel Px, a droplet 61 is disposed in the space 60. The droplet 61 has a light blocking property. As the droplet 61 having the light blocking property, for example, conductive liquid such as ionic liquids and polar liquids that are colored by adding pigments or dyes can be used. Here, the droplet 61 is colored in black. Specific examples of the conductive liquid include water, an electrolyte (aqueous solution of an electrolyte), and alcohols. Note that a non-conductive liquid that is immiscible with the droplet 61 may be injected into the space 60 (i.e., a space not occupied by the droplet 61 may be filled with the non-conductive liquid).

The first substrate 40 includes a first electrode E1 and a plurality of second electrodes E2 in each pixel Px. The first electrode E1 is positioned so as to include a portion that is not located within the opening region R1 (i.e., located within the light blocking region R2). In the illustrated example, the first electrode E1 includes a portion located within the opening region R1 in addition to a portion located within the light blocking region R2, but does not have to include a portion located within the opening region R1. The plurality of second electrodes E2 are located so as to be at least partially positioned within the opening region R1.

The first substrate 40 further includes a transparent substrate 41. The transparent substrate 41 is, for example, a glass substrate with a thickness of 0.7 mm. The first electrode E1 and the plurality of second electrodes E2 are provided on a space 60 side of the transparent substrate 41, and are supported by the transparent substrate 41. The first electrode E1 and the plurality of second electrodes E2 can be formed, for example, by depositing an ITO film with a thickness of 0.1 μm by sputtering, and then patterning the ITO film by a photolithography process and etching.

The second substrate 50 includes a plurality of third electrodes E3 in each pixel Px. The plurality of third electrodes E3 are located so as to be at least partially positioned within the opening region R1. A potential different from that applied to the plurality of second electrodes E2 is applied to at least one of the plurality of third electrodes E3.

The second substrate 50 further includes a transparent substrate 51. The transparent substrate 51 is, for example, a glass substrate with a thickness of 0.7 mm. The plurality of third electrodes E3 are provided on a space 60 side of the transparent substrate 51, and are supported by the transparent substrate 51. The plurality of third electrodes E3 can be formed, for example, by depositing an ITO film with a thickness of 0.1 μm by sputtering, and then patterning the ITO film by a photolithography process and etching.

In the illustrated example, a first dielectric layer 42 is provided so as to cover the transparent substrate 41, the first electrode E1, and the plurality of second electrodes E2, and a first water-repellent layer 43 is formed on the first dielectric layer 42. A second dielectric layer 52 is provided so as to cover the transparent substrate 51 and the plurality of third electrodes E3, and a second water-repellent layer 53 is formed on the second dielectric layer 52. Thus, the first substrate 40 and the second substrate 50 have the first water-repellent layer 43 and the second water-repellent layer 53, respectively, which are provided so as to face the space 60.

Each of the first water-repellent layer 43 and the second water-repellent layer 53 is a fluororesin layer having a thickness of, for example, from 30 nm to 100 nm. Each of the first dielectric layer 42 and the second dielectric layer 52 is a silicon nitride (SiN) layer having a thickness of, for example, from 100 nm to 500 nm.

The first substrate 40 and the second substrate 50 are bonded together with a seal member (not illustrated). A distance between the first substrate 40 and the second substrate 50 (i.e., a thickness of the space 60) is, for example, from 10 μm to 100 μm, and is defined by, for example, spacers included in the seal member.

In the present embodiment, in a plan view, one of the plurality of second electrodes E2 and one of the plurality of third electrodes E3 are alternately arranged along a predetermined direction. In the illustrated example, the third electrode E3, the second electrode E2, the third electrode E3, and the second electrode E2 are arranged in this order along a direction from a left side to a right side in the figure. In the present embodiment, in each pixel Px, the second electrodes E2 and the third electrodes E3 adjacent to each other partially overlap each other in a plan view.

Note that an example is illustrated here in which the first substrate 40 includes the first electrode E1, but the second substrate 50 may include the first electrode E1. The number of the second electrodes E2 and the number of the third electrodes E3 are not limited to two exemplified in FIG. 26. Shapes of the first electrode E1, the second electrodes E2, and the third electrodes E3 are not limited to the illustrated shape (strip shape).

Next, the operation of the electrowetting element 200 will be described.

When a voltage is applied to the droplet 61, a contact angle of the droplet 61 relative to the first dielectric layer 42 and/or the second dielectric layer 52 changes. By reducing the contact angle (i.e., by improving wettability), the droplet 61 can spread (i.e., move) on a surface of the first substrate 40 and/or the second substrate 50 on the space 60 side. Therefore, by controlling potentials of the first electrode E1, the plurality of second electrodes E2, and the plurality of third electrodes E3, the electrowetting element 200 can switch between a state in which the opening region R1 transmits light (hereinafter referred to as a "light transmitting state" of the pixel Px) and a state in which the opening region R1 blocks light (hereinafter referred to as a "light blocking state" of the pixel Px).

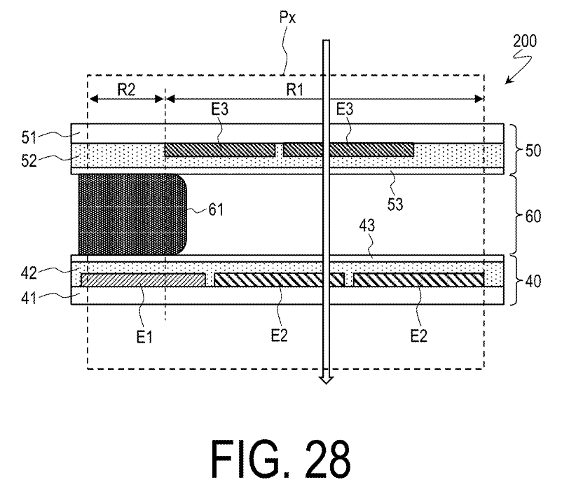

FIG. 28 illustrates the light transmitting state described above. By applying a positive potential to the first electrode E1, the wettability of a portion of the surface of the first substrate 40 that is located on the first electrode E1 is improved. Consequently, most of the droplet 61 moves toward the first electrode E1, thereby achieving the light transmitting state in which most of the droplet 61 is not located within the opening region R1 (i.e., located near the first electrode E1 within the light blocking region R2), as illustrated in FIG. 28. At this time, for example, a ground potential (0 V) is applied to the second electrodes E2 and the third electrodes E3.

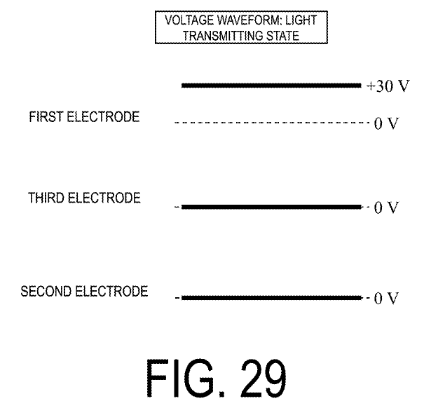

FIG. 29 illustrates an example of waveforms of voltages applied to the first electrode E1, the second electrodes E2, and the third electrodes E3, when achieving the light transmitting state. In the example illustrated in FIG. 29, the voltage applied to the first electrode E1 is a DC voltage of +30 V, and the voltage applied to the second electrodes E2 and the third electrodes E3 is 0 V (or a negative potential).

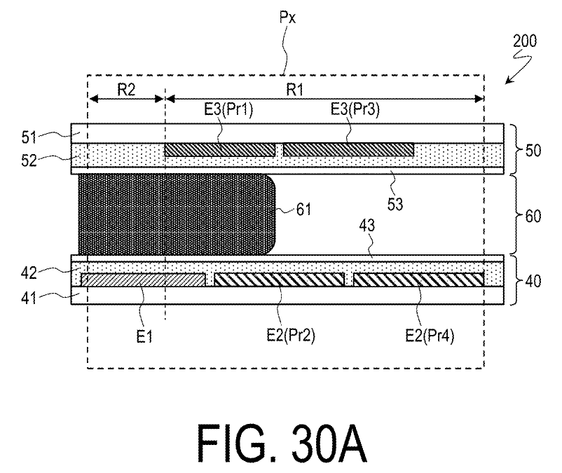

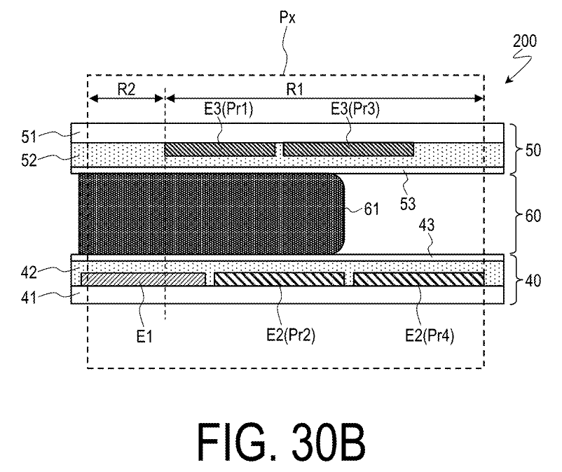

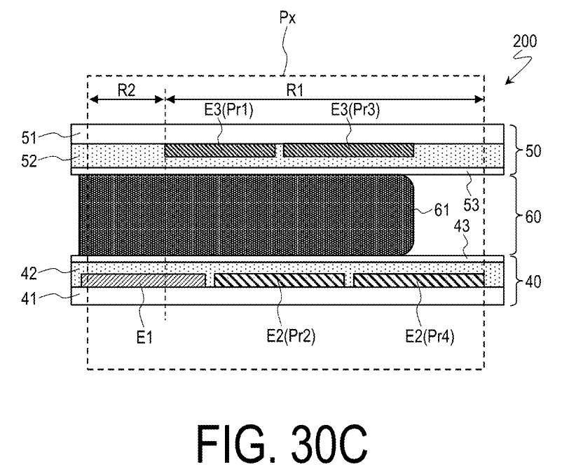

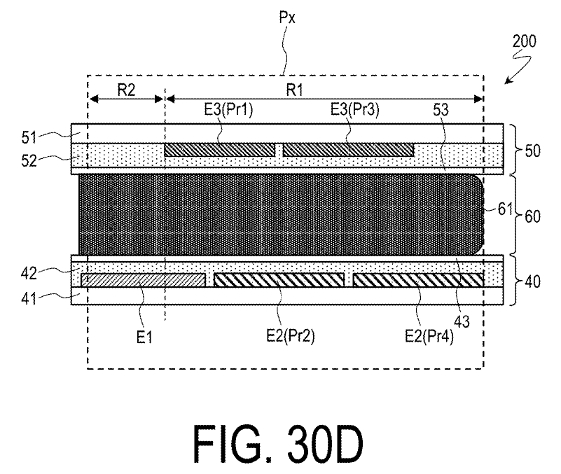

FIGS. 30A to 30D sequentially illustrate transition from the light transmitting state to the light blocking state described above (i.e., movement of the droplet 61 into the opening region R1). In the following description, among the plurality of second electrodes E2 and the plurality of third electrodes E3, an electrode closest to the first electrode E1, an electrode second closest to the first electrode E1, an electrode third closest to the first electrode E1, and an electrode fourth closest to the first electrode E1 (i.e., an electrode farthest from the first electrode E1) are referred to as a first proximal electrode Pr1, a second proximal electrode Pr2, a third proximal electrode Pr3, and a fourth proximal electrode Pr4, respectively.

First, by applying a positive potential to the third electrodes E3 and applying the ground potential (or a negative potential) to the second electrodes E2, the droplet 61 is spread from near the first electrode E1 toward the first proximal electrode Pr1 (the third electrode E3 on a left side of the two third electrodes E3), as illustrated in FIG. 30A. At this time, the ground potential (0 V), for example, is applied to the first electrode E1.

Next, by applying the ground potential (or a negative potential) to the third electrodes E3 and applying a positive potential to the second electrodes E2, the droplet 61 is further spread toward the second proximal electrode Pr2 (the second electrode E2 on a left side of the two second electrodes E2), as illustrated in FIG. 30B.

Subsequently, by applying a positive potential to the third electrodes E3 and applying the ground potential (or a negative potential) to the second electrodes E2, the droplet 61 is spread toward the third proximal electrode Pr3 (the third electrode E3 on a right side of the two third electrodes E3), as illustrated in FIG. 30C.

Thereafter, by applying the ground potential (or a negative potential) to the third electrodes E3 and applying a positive potential to the second electrodes E2, the droplet 61 is further spread toward the fourth proximal electrode Pr4 (the second electrode E2 on a right side of the two second electrodes E2), as illustrated in FIG. 30D.

In this manner, by sequentially spreading (attracting) the droplet 61 toward the first proximal electrode Pr1, the second proximal electrode Pr2, the third proximal electrode Pr3, and the fourth proximal electrode Pr4, the light blocking state in which the droplet 61 is located within the opening region R1 can be achieved.

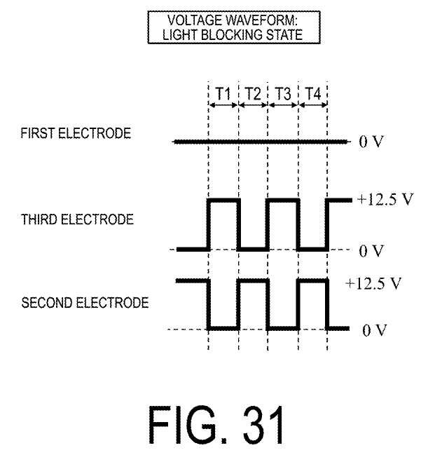

FIG. 31 illustrates an example of waveforms of voltages applied to the first electrode E1, the second electrodes E2, and the third electrodes E3, when achieving the light blocking state. In FIG. 31, an attraction period to the first proximal electrode Pr1 is denoted by T1, an attraction period to the second proximal electrode Pr2 is denoted by T2, an attraction period to the third proximal electrode Pr3 is denoted by T3, and an attraction period to the fourth proximal electrode Pr4 is denoted by T4.

In the example illustrated in FIG. 31, the voltage applied to the first electrode E1 is 0 V. The voltage applied to the third electrodes E3 is a DC voltage that changes from +12.5 V to 0 V, then to +12.5 V, and then to 0 V from a start of the period T1, and the voltage applied to the second electrodes E2 is a DC voltage that changes from 0 V to +12.5 V, then to 0 V, and then to +12.5 V from the start of the period T1. That is, DC voltages of opposite phases are applied to the plurality of second electrodes E2 and the plurality of third electrodes E3. A frequency of the DC voltage applied to the second electrodes E2 and the third electrodes E3 is, for example, 0.5 Hz.

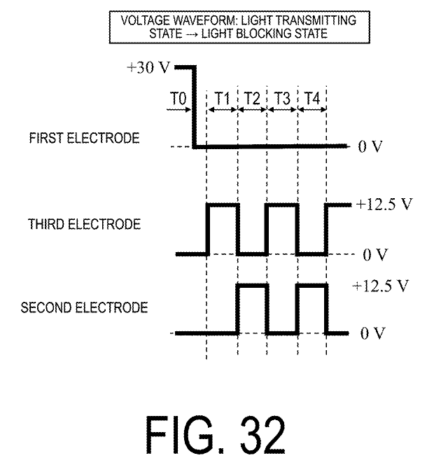

FIG. 32 illustrates another example of waveforms of voltages applied to the electrodes. In FIG. 32, a period during which the droplet 61 is attracted to the first electrode E1 is denoted by T0. In the example illustrated in FIG. 32, first, a DC voltage of +30 V is applied to the first electrode E1 to attract most of the droplet 61 within the opening region R1 to the first electrode E1 (initialization), and then DC voltages similar to those illustrated in FIG. 31 are applied to the second electrodes E2 and the third electrodes E3 to move the droplet 61 into the opening region R1.

Here, another example of a voltage application mode will be described.

First, by applying a positive potential to the first electrode E1, the droplet 61 moves toward the first electrode E1, thereby achieving the light transmitting state. At this time, for example, the ground potential (0 V) (or a negative potential) is applied to the second electrodes E2 and the third electrodes E3.

Next, by applying a positive potential to the first proximal electrode Pr1 and applying the ground potential (or a negative potential) to the second proximal electrode Pr2 and the third proximal electrode Pr3, the droplet 61 is spread from near the first electrode E1 toward the first proximal electrode Pr1. At this time, a positive potential, the ground potential, or a negative potential may be applied to the fourth proximal electrode Pr4. The ground potential (0 V), for example, is applied to the first electrode E1.

Subsequently, by applying a positive potential to the second proximal electrode Pr2 and applying the ground potential (or a negative potential) to the first proximal electrode Pr1, the third proximal electrode Pr3, and the fourth proximal electrode Pr4, the droplet 61 is further spread toward the second proximal electrode Pr2.

Next, by applying a positive potential to the third proximal electrode Pr3 and applying the ground potential (or a negative potential) to the first proximal electrode Pr1, the second proximal electrode Pr2, and the fourth proximal electrode Pr4, the droplet 61 is further spread toward the third proximal electrode Pr3.

Thereafter, by applying a positive potential to the fourth proximal electrode Pr4 and applying the ground potential (or a negative potential) to the second proximal electrode Pr2 and the third proximal electrode Pr3, the droplet 61 is further spread toward the fourth proximal electrode Pr4. At this time, a positive potential, the ground potential, or a negative potential may be applied to the first proximal electrode Pr1.

In this manner, by sequentially spreading (attracting) the droplet 61 toward the first proximal electrode Pr1, the second proximal electrode Pr2, the third proximal electrode Pr3, and the fourth proximal electrode Pr4, the light blocking state in which the droplet 61 is located within the opening region R1 can be achieved.

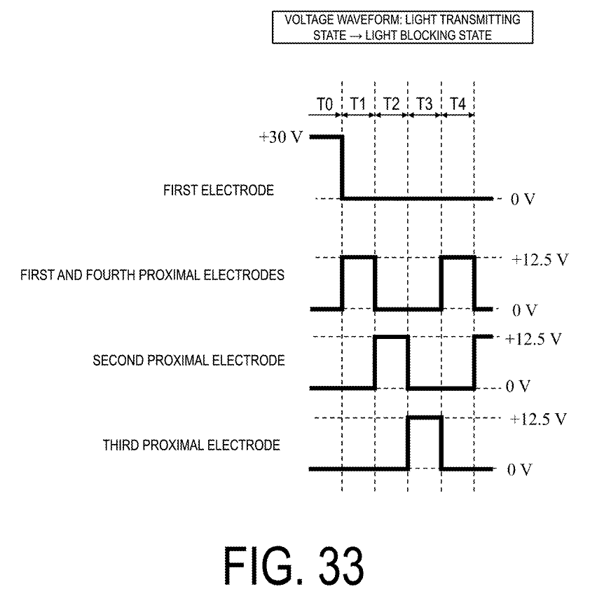

FIG. 33 illustrates an example of voltage waveforms used in this mode.

In the example illustrated in FIG. 33, a DC voltage of +30 V is applied to the first electrode E1 during the period T0 in which the droplet 61 is attracted to the first electrode E1, and the ground potential (0 V) (or a negative potential) is applied during the other periods T1, T2, T3, and T4. A DC voltage of +12.5 V is applied to the first proximal electrode Pr1 and the fourth proximal electrode Pr4 during the period T1 in which the droplet 61 is attracted to the first proximal electrode Pr1 and the period T4 during which the droplet 61 is attracted to the fourth proximal electrode Pr4, and a DC voltage of 0 V is applied to the other periods, T0, T2, and T3. A DC voltage of +12.5 V is applied to the second proximal electrode Pr2 during the period T2 in which the droplet 61 is attracted to the second proximal electrode Pr2, and a DC voltage of 0 V is applied during the other periods T0, T1, T3, and T4. A DC voltage of +12.5 V is applied to the third proximal electrode Pr3 during the period T3 in which the droplet 61 is attracted to the third proximal electrode Pr3, and a DC voltage of 0 V is applied during the other periods T0, T1, T2, and T4. A length of each of the periods T1, T2, T3, and T4 is, for example, 125 ms.

Note that FIG. 33 illustrates an example in which lengths of the periods T1, T2, T3, and T4 are all the same, but the lengths of the periods T1, T2, T3, and T4 do not need to be the same. A length t1 of the period T1, a length t2 of the period T2, and a length t3 of the period T3 may satisfy, for example, a relationship t1 > t2 > t3 or may satisfy a relationship t1 < t2 < t3.

FIG. 33 illustrates an example in which magnitudes of the positive DC voltages applied to the first proximal electrode Pr1, the second proximal electrode Pr2, the third proximal electrode Pr3, and the fourth proximal electrode Pr4 are all the same, but they do not need to be the same. When a magnitude of the positive DC voltage applied to the first proximal electrode Pr1 is V1, a magnitude of the positive DC voltage applied to the second proximal electrode Pr2 is V2, and a magnitude of the positive DC voltage applied to the third proximal electrode Pr3 is V3, for example, a relationship V1 > V2 > V3 or a relationship V1 < V2 < V3 may be satisfied.

From the viewpoint of suitably moving (spreading) the droplet 61 into the opening region R1, it is preferable that, as exemplified, in each pixel Px, the second electrodes E2 and the third electrodes E3 adjacent to each other partially overlap in a plan view.

The first electrode E1 of each pixel Px may be electrically independent of the first electrodes E1 of the other pixels Px. For example, the electrowetting element 200 may include, in addition to the first electrodes E1 and the like already described, a plurality of gate wiring lines extending along a row direction, a plurality of source wiring lines extending along a column direction, and TFTs that are provided corresponding to the pixels Px and are supplied with gate signals and source signals from corresponding gate wiring lines and source wiring lines (neither of which are illustrated). In this case, the first electrode E1 is electrically connected to a drain electrode of the TFT. In this case, each second electrode E2 may be a common electrode that extends across all pixel rows along the column direction and to which a common potential is applied across an entire one pixel column. Similarly, each third electrode E3 may be a common electrode that extends across all pixel rows along the column direction and to which a common potential is applied across the entire one pixel column.

### Fourth Embodiment

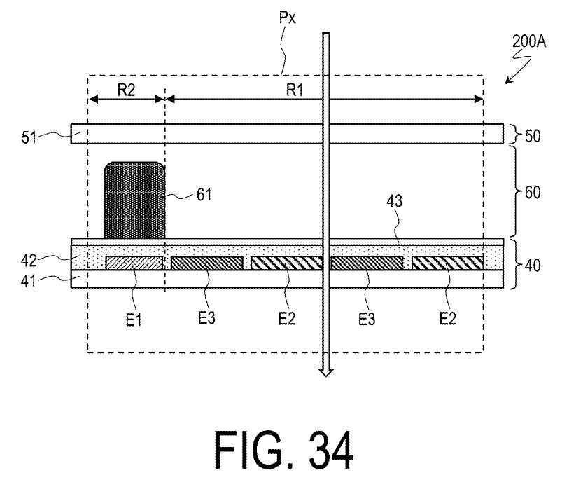

An electrowetting element 200A according to the present embodiment will be described with reference to FIG. 34. FIG. 34 is a cross-sectional view schematically illustrating the electrowetting element 200A, illustrating a region corresponding to one pixel Px of the electrowetting element 200A. The electrowetting element 200A according to the present embodiment is suitably used as a light shutter panel, similar to the electrowetting element 200 according to the third embodiment. The following description will focus on differences between the electrowetting element 200A and the electrowetting element 200 of the third embodiment.

The electrowetting element 200A differs from the electrowetting element 200 of the third embodiment in that a first substrate 40 includes a plurality of third electrodes E3. That is, in the electrowetting element 200A, the first substrate 40 includes both the second electrodes E2 and the third electrodes E3.

The plurality of third electrodes E3 are provided on a space 60 side of a transparent substrate 41 and supported by the transparent substrate 41, together with a first electrode E1 and the plurality of second electrodes E2. The plurality of third electrodes E3 are covered with a first dielectric layer 42 together with the first electrode E1 and the plurality of second electrodes E2.

A second substrate 50 does not include the second electrodes E2 or the third electrodes E3, and does not include a dielectric layer or a water-repellent layer.

In the present embodiment, in a plan view, one of the plurality of second electrodes E2 and one of the plurality of third electrodes E3 are alternately arranged along a predetermined direction. In the illustrated example, the third electrode E3, the second electrode E2, the third electrode E3, and the second electrode E2 are arranged in this order along a direction from a left side to a right side in the figure.

Next, the operation of the electrowetting element 200A will be described.

The electrowetting element 200A, similar to the electrowetting element 200 of the third embodiment, can switch the pixel Px between a light transmitting state and a light blocking state by controlling potentials of the first electrode E1, the plurality of second electrodes E2, and the plurality of third electrodes E3.

FIG. 34 illustrates the light transmitting state. By applying a positive potential to the first electrode E1, most of the droplet 61 moves toward the first electrode E1, thereby achieving the light transmitting state in which most of the droplet 61 is not located within an opening region R1 (i.e., located near the first electrode E1 within a light blocking region R2), as illustrated in FIG. 34. At this time, for example, a ground potential (0 V) is applied to the second electrodes E2 and the third electrodes E3.

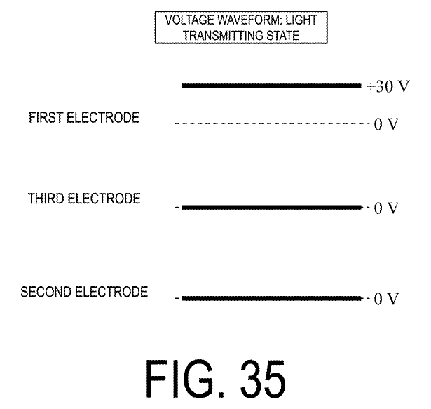

FIG. 35 illustrates an example of waveforms of voltages applied to the first electrode E1, the second electrodes E2, and the third electrodes E3, when achieving the light transmitting state. In the example illustrated in FIG. 35, the voltage applied to the first electrode E1 is a DC voltage of +30 V, and the voltage applied to the second electrodes E2 and the third electrodes E3 is 0 V.

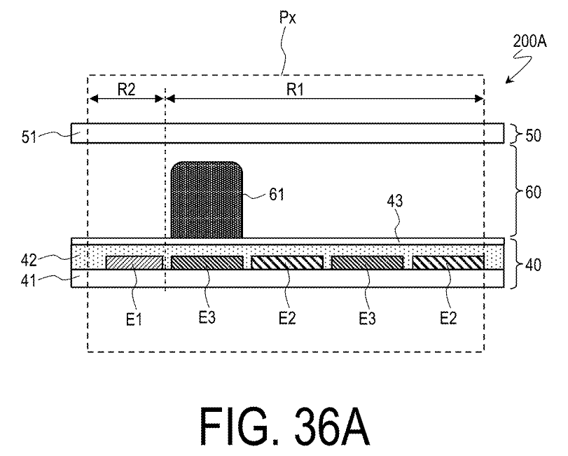

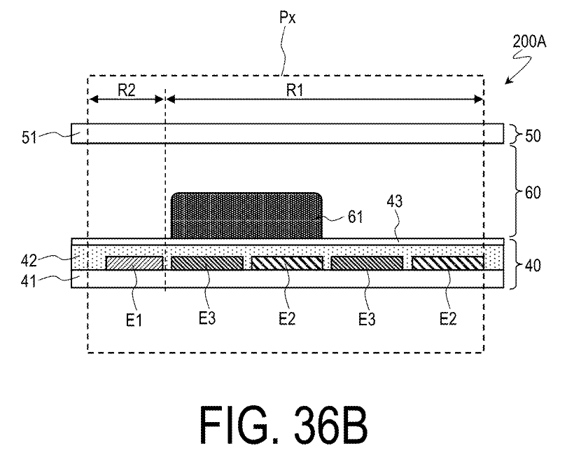

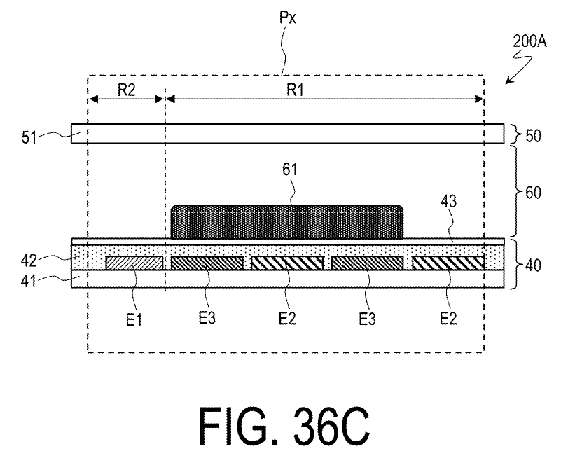

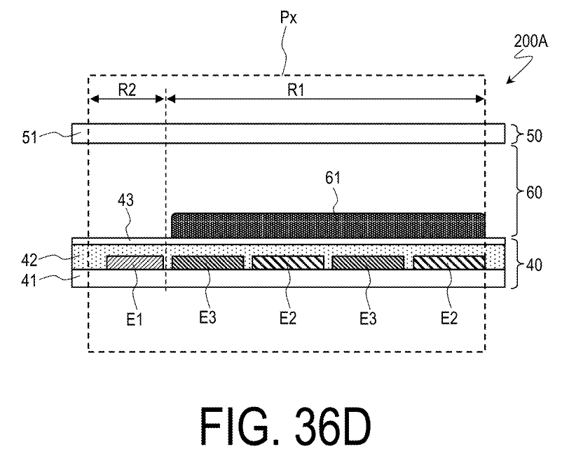

FIGS. 36A to 36D sequentially illustrate transition from the light transmitting state to the light blocking state described above (i.e., movement of the droplet 61 into the opening region R1). In the following description as well, among the plurality of second electrodes E2 and the plurality of third electrodes E3, an electrode closest to the first electrode E1, an electrode second closest to the first electrode E1, an electrode third closest to the first electrode E1, and an electrode fourth closest to the first electrode E1 (i.e., an electrode farthest from the first electrode E1) are referred to as a first proximal electrode Pr1, a second proximal electrode Pr2, a third proximal electrode Pr3, and a fourth proximal electrode Pr4, respectively.

First, by applying a positive potential to the third electrodes E3 and applying the ground potential (or a negative potential) to the second electrodes E2, the droplet 61 is moved from near the first electrode E1 toward the first proximal electrode Pr1 (the third electrode E3 on a left side of the two third electrodes E3), as illustrated in FIG. 36A. At this time, the ground potential (0 V), for example, is applied to the first electrode E1.

Next, by applying the ground potential (or a negative potential) to the third electrodes E3 and applying a positive potential to the second electrodes E2, the droplet 61 is spread toward the second proximal electrode Pr2 (the second electrode E2 on a left side of the two second electrodes E2), as illustrated in FIG. 36B.

Subsequently, by applying a positive potential to the third electrodes E3 and applying the ground potential (or a negative potential) to the second electrodes E2, the droplet 61 is spread toward the third proximal electrode Pr3 (the third electrode E3 on a right side of the two third electrodes E3), as illustrated in FIG. 36C.

Thereafter, by applying the ground potential (or a negative potential) to the third electrodes E3 and applying a positive potential to the second electrodes E2, the droplet 61 is further spread toward the fourth proximal electrode Pr4 (the second electrode E2 on a right side of the two second electrodes E2), as illustrated in FIG. 36D.

In this manner, by sequentially spreading (attracting) the droplet 61 toward the first proximal electrode Pr1, the second proximal electrode Pr2, the third proximal electrode Pr3, and the fourth proximal electrode Pr4, the light blocking state in which the droplet 61 is located within the opening region R1 can be achieved.

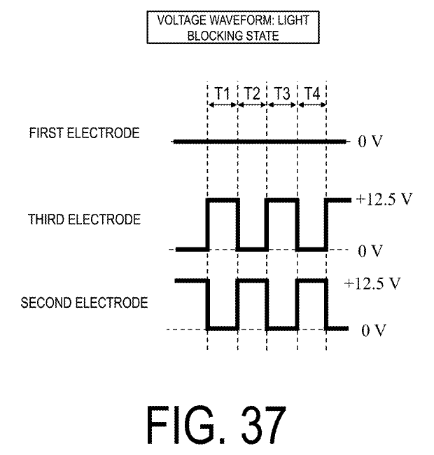

FIG. 37 illustrates an example of waveforms of voltages applied to the first electrode E1, the second electrodes E2, and the third electrodes E3, when achieving the light blocking state. In FIG. 37, an attraction period to the first proximal electrode Pr1 is denoted by T1, an attraction period to the second proximal electrode Pr2 is denoted by T2, an attraction period to the third proximal electrode Pr3 is denoted by T3, and an attraction period to the fourth proximal electrode Pr4 is denoted by T4.

In the example illustrated in FIG. 37, the voltage applied to the first electrode E1 is 0 V. The voltage applied to the third electrodes E3 is a DC voltage that changes from +12.5 V to 0 V, then to +12.5 V, and then to 0 V from a start of the period T1, and the voltage applied to the second electrodes E2 is a DC voltage that changes from 0 V to +12.5 V, then to 0 V, and then to +12.5 V from the start of the period T1. That is, DC voltages of opposite phases are applied to the plurality of second electrodes E2 and the plurality of third electrodes E3. A frequency of the DC voltage applied to the second electrodes E2 and the third electrodes E3 is, for example, 0.5 Hz.

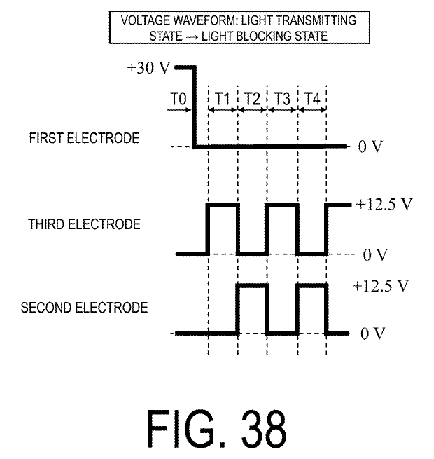

FIG. 38 illustrates another example of waveforms of voltages applied to the electrodes. In FIG. 38, a period during which the droplet 61 is attracted to the first electrode E1 is denoted by T0. In the example illustrated in FIG. 38, first, a DC voltage of +30 V is applied to the first electrode E1 to attract most of the droplet 61 within the opening region R1 to the first electrode E1 (initialization), and then DC voltages similar to those illustrated in FIG. 37 are applied to the second electrodes E2 and the third electrodes E3 to move the droplet 61 into the opening region R1.

Thus, in the electrowetting element 200A of the present embodiment as well, the droplet 61 can be sequentially attracted to the first proximal electrode Pr1, the second proximal electrode Pr2, the third proximal electrode Pr3, and the fourth proximal electrode Pr4, thereby enabling the droplet 61 to be suitably moved into the opening region R1.

Note that FIGS. 37 and 38 illustrate examples in which the same potential is applied to the plurality of second electrodes E2 and the same potential is applied to the plurality of third electrodes E3, but the mode of voltage application is not limited thereto. In each pixel Px, the plurality of second electrodes E2 may include two second electrodes E2 to which different potentials are applied, and the plurality of third electrodes E3 may include two third electrodes E3 to which different potentials are applied. In this case, in each pixel Px, the same potential may be applied to a certain second electrode E2 of the plurality of second electrodes E2 and a certain third electrode E3 of the plurality of third electrodes E3.

Here, another example of a voltage application mode will be described.

First, by applying a positive potential to the first electrode E1, the droplet 61 moves toward the first electrode E1, thereby achieving the light transmitting state. At this time, for example, the ground potential (0 V) (or a negative potential) is applied to the second electrodes E2 and the third electrodes E3.

Next, by applying a positive potential to the first proximal electrode Pr1 and applying the ground potential (or a negative potential) to the second proximal electrode Pr2 and the third proximal electrode Pr3, the droplet 61 is moved from near the first electrode E1 toward the first proximal electrode Pr1. At this time, a positive potential, the ground potential, or a negative potential may be applied to the fourth proximal electrode Pr4. The ground potential (0 V), for example, is applied to the first electrode E1.

Subsequently, by applying a positive potential to the second proximal electrode Pr2 and applying the ground potential (or a negative potential) to the first proximal electrode Pr1, the third proximal electrode Pr3, and the fourth proximal electrode Pr4, the droplet 61 is spread toward the second proximal electrode Pr2.

Next, by applying a positive potential to the third proximal electrode Pr3 and applying the ground potential (or a negative potential) to the first proximal electrode Pr1, the second proximal electrode Pr2, and the fourth proximal electrode Pr4, the droplet 61 is further spread toward the third proximal electrode Pr3.

Thereafter, by applying a positive potential to the fourth proximal electrode Pr4 and applying the ground potential (or a negative potential) to the second proximal electrode Pr2 and the third proximal electrode Pr3, the droplet 61 is further spread toward the fourth proximal electrode Pr4. At this time, a positive potential, the ground potential, or a negative potential may be applied to the first proximal electrode Pr1.

In this manner, by sequentially spreading (attracting) the droplet 61 onto the first proximal electrode Pr1, the second proximal electrode Pr2, the third proximal electrode Pr3, and the fourth proximal electrode Pr4, the light blocking state in which the droplet 61 is located within the opening region R1 can be achieved.

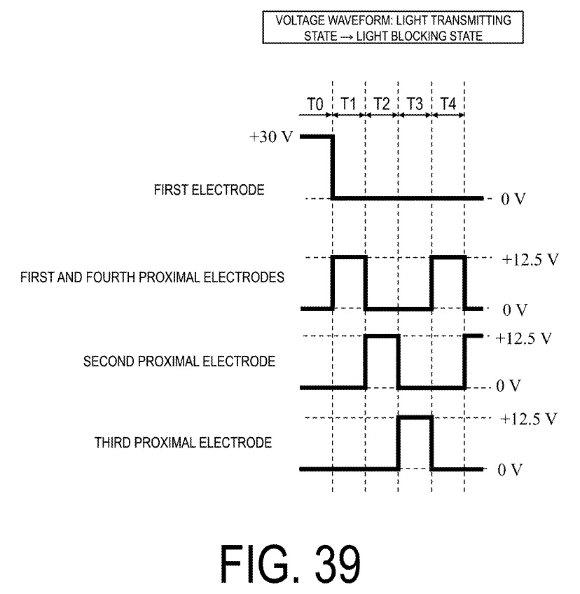

FIG. 39 illustrates an example of voltage waveforms used in this mode.

In the example illustrated in FIG. 39, a DC voltage of +30 V is applied to the first electrode E1 during the period T0 in which the droplet 61 is attracted to the first electrode E1, and the ground potential (0 V) is applied during the other periods T1, T2, T3, and T4. A DC voltage of +12.5 V is applied to the first proximal electrode Pr1 and the fourth proximal electrode Pr4 during the period T1 in which the droplet 61 is attracted to the first proximal electrode Pr1 and the period T4 during which the droplet 61 is attracted to the fourth proximal electrode Pr4, and a DC voltage of 0 V is applied to the other periods, T0, T2, and T3. A DC voltage of +12.5 V is applied to the second proximal electrode Pr2 during the period T2 in which the droplet 61 is attracted to the second proximal electrode Pr2, and a DC voltage of 0 V is applied during the other periods T0, T1, T3, and T4. A DC voltage of +12.5 V is applied to the third proximal electrode Pr3 during the period T3 in which the droplet 61 is attracted to the third proximal electrode Pr3, and a DC voltage of 0 V is applied during the other periods T0, T1, T2, and T4. A length of each of the periods T1, T2, T3, and T4 is, for example, 125 ms.

Note that FIG. 39 illustrates an example in which lengths of the periods T1, T2, T3, and T4 are all the same, but the lengths of the periods T1, T2, T3, and T4 do not need to be the same. A length t1 of the period T1, a length t2 of the period T2, and a length t3 of the period T3 may satisfy, for example, a relationship t1 > t2 > t3 or may satisfy a relationship t1 < t2 < t3.

FIG. 39 illustrates an example in which magnitudes of the positive DC voltages applied to the first proximal electrode Pr1, the second proximal electrode Pr2, the third proximal electrode Pr3, and the fourth proximal electrode Pr4 are all the same, but they do not need to be the same. When a magnitude of the positive DC voltage applied to the first proximal electrode Pr1 is V1, a magnitude of the positive DC voltage applied to the second proximal electrode Pr2 is V2, and a magnitude of the positive DC voltage applied to the third proximal electrode Pr3 is V3, for example, a relationship V1 > V2 > V3 or a relationship V1 < V2 < V3 may be satisfied.

Note that a configuration in which the first substrate 40 includes both the second electrodes E2 and the third electrodes E3 is exemplified here, but a configuration in which the second substrate 50 includes both the second electrodes E2 and the third electrodes E3 may be adopted. The configuration in which one of the first substrate 40 and the second substrate 50 includes both the second electrodes E2 and the third electrodes E3 has an advantage of easy manufacturing, in that a circuit is formed on only one substrate. In contrast, a configuration such as the electrowetting element 200 of the third embodiment, in which the first substrate 40 includes the second electrodes E2 and the second substrate 50 includes the third electrodes E3, has an advantage that the droplet 61 moves more readily because an electrical field is applied obliquely.

In the electrowetting element 200 of the third embodiment and the electrowetting element 200A of the fourth embodiment, in addition to the first electrode E1, an electrode to which the same potential as that of the second electrodes E2 is applied and/or an electrode to which the same potential as that of the third electrodes E3 is applied may be provided in the light blocking region R2.

### Display Device Including Electrowetting Element

As already described, the electrowetting elements 200 and 200A are suitable for use as light shutter panels. Here, an example of a transparent display (display device) that includes the electrowetting element 200 (or 200A) as a light shutter panel will be described.

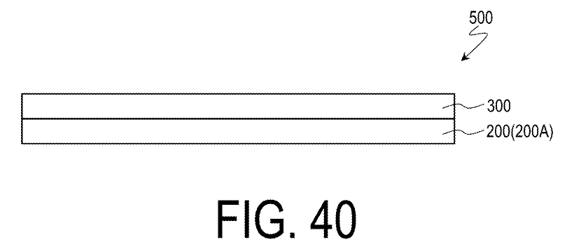

FIG. 40 is a diagram schematically illustrating a display device (transparent display) 500. As illustrated in FIG. 40, the display device 500 includes a display panel 300 and the electrowetting element (light shutter panel) 200 (or 200A).

The display panel 300 is a self-luminous type. The self-luminous display panel 300 may be, for example, an OLED display panel, a μLED display panel, a QD-LED display panel, or a nanoLED display panel.

The electrowetting element 200 (or 200A) is positioned so as to overlap the display panel 300. The electrowetting element 200 (or 200A) is positioned on a back side of the display panel 300 (a side opposite to a viewer side).

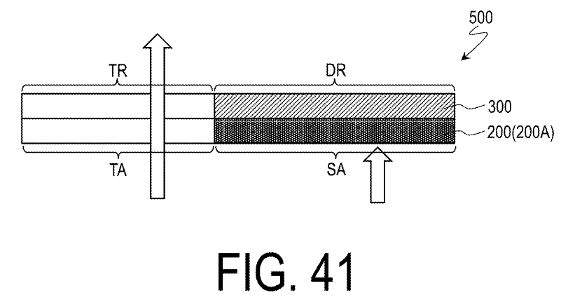

FIG. 41 illustrates a state in which an image is displayed on a portion of a displayable region of the display panel 300 (hereinafter referred to as an "image display region") DR, and no image is displayed in another region (hereinafter referred to as a "transparent region") TR. In this state, the pixels Px in a region SA of the electrowetting element 200 (or 200A) that overlaps the image display region DR of the display panel 300 in a plan view are set to the light blocking state, and the pixels Px in a region TA that overlaps the transparent region TR of the display panel 300 in a plan view are set to the light transmitting state, thereby suppressing display distortion and a decrease in contrast ratio in the image display region DR while maintaining transparency of the transparent region TR.

### INDUSTRIAL APPLICABILITY

The electrophoretic element and the electrowetting element according to the embodiments of the disclosure can be used for various applications, and can be suitably used, for example, as light shutter panels.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. An electrophoretic element comprising:
a first substrate and a second substrate facing each other;
an electrophoretic layer provided between the first substrate and the second substrate; and
a plurality of pixels each including an opening region configured to transmit light from the electrophoretic layer to a front side,
the electrophoretic layer including a dispersion medium and a plurality of electrophoretic particles dispersed in the dispersion medium in each of the plurality of pixels,
wherein in each of the plurality of pixels, the electrophoretic element further includes
a first electrode arranged in a manner as to be not located within the opening region,
a plurality of second electrodes arranged in a manner as to be at least partially located within the opening region, and
a plurality of third electrodes arranged in a manner as to be at least partially located within the opening region and configured such that a potential different from a potential applied to the plurality of second electrodes is applied to at least one of the plurality of third electrodes, and
in a plan view, one of the plurality of second electrodes and one of the plurality of third electrodes are alternately arranged along a predetermined direction.

2. The electrophoretic element according to claim 1,
wherein the plurality of second electrodes and the plurality of third electrodes do not overlap each other in a plan view.

3. The electrophoretic element according to claim 1,
wherein in each of the plurality of pixels, potentials applied to the plurality of second electrodes are identical to each other, and potentials applied to the plurality of third electrodes are identical to each other.

4. The electrophoretic element according to claim 3,
wherein during transition of each of the plurality of pixels from a state where the plurality of electrophoretic particles are located near the first electrode to a state where the plurality of electrophoretic particles are located within the opening region, DC voltages of opposite phases are applied to the plurality of second electrodes and the plurality of third electrodes.

5. The electrophoretic element according to claim 1,
wherein in each of the plurality of pixels, the plurality of second electrodes include two second electrodes to which potentials different from each other are applied, and the plurality of third electrodes include two third electrodes to which potentials different from each other are applied.

6. The electrophoretic element according to claim 5,
wherein in each of the plurality of pixels, a potential applied to a certain second electrode of the plurality of second electrodes is identical to a potential applied to a certain third electrode of the plurality of third electrodes.

7. The electrophoretic element according to claim 5,
wherein, of a positive polarity and a negative polarity, a polarity to which the plurality of electrophoretic particles are charged is defined as a first polarity, and a polarity opposite to the first polarity is defined as a second polarity, and further,
among the plurality of second electrodes and the plurality of third electrodes, an electrode closest to the first electrode, an electrode second closest to the first electrode, and an electrode third closest to the first electrode are defined as a first proximal electrode, a second proximal electrode, and a third proximal electrode, respectively,
during transition of each of the plurality of pixels from a state where the plurality of electrophoretic particles are located near the first electrode to a state where the plurality of electrophoretic particles are located within the opening region, the following states are sequentially formed by applying DC voltages to the plurality of second electrodes and the plurality of third electrodes:
(1) a state where the first proximal electrode is at the second polarity and the second proximal electrode and the third proximal electrode are at a ground potential or the first polarity,
(2) a state where the second proximal electrode is at the second polarity and the first proximal electrode and the third proximal electrode are at the ground potential or the first polarity, and
(3) a state where the third proximal electrode is at the second polarity and the first proximal electrode and the second proximal electrode are at the ground potential or the first polarity.

8. The electrophoretic element according to claim 7,
wherein a length of time t1 during which a DC voltage of the second polarity is applied to the first proximal electrode, a length of time t2 during which a DC voltage of the second polarity is applied to the second proximal electrode, and a length of time t3 during which a DC voltage of the second polarity is applied to the third proximal electrode satisfy a relationship t1 > t2 > t3.

9. The electrophoretic element according to claim 7,
wherein a length of time t1 during which a DC voltage of the second polarity is applied to the first proximal electrode, a length of time t2 during which a DC voltage of the second polarity is applied to the second proximal electrode, and a length of time t3 during which a DC voltage of the second polarity is applied to the third proximal electrode satisfy a relationship t1 < t2 < t3.

10. The electrophoretic element according to claim 7,
wherein a magnitude V1 of a DC voltage of the second polarity applied to the first proximal electrode, a magnitude V2 of a DC voltage of the second polarity applied to the second proximal electrode, and a magnitude V3 of a DC voltage of the second polarity applied to the third proximal electrode satisfy a relationship V1 > V2 > V3.

11. The electrophoretic element according to claim 7,
wherein a magnitude V1 of a DC voltage of the second polarity applied to the first proximal electrode, a magnitude V2 of a DC voltage of the second polarity applied to the second proximal electrode, and a magnitude V3 of a DC voltage of the second polarity applied to the third proximal electrode satisfy a relationship V1 < V2 < V3.

12. The electrophoretic element according to claim 1,
wherein the first electrode of each of the plurality of pixels is electrically independent of the first electrodes of other pixels.

13. The electrophoretic element according to claim 12 further comprising:
a thin film transistor provided in each of the plurality of pixels;
a gate wiring line electrically connected to a gate electrode of the thin film transistor; and
a source wiring line electrically connected to a source electrode of the thin film transistor,
wherein the first electrode of each of the plurality of pixels is electrically connected to a drain electrode of the thin film transistor.

14. The electrophoretic element according to claim 13,
wherein the plurality of pixels are arranged in a matrix including a plurality of rows and a plurality of columns,
the gate wiring line extends along a row direction, and the source wiring line extends along a column direction, and
the plurality of second electrodes and the plurality of third electrodes each are a common electrode extending along the column direction and configured such that a common potential across one pixel column is applied.

15. The electrophoretic element according to claim 1,
wherein the first substrate includes the plurality of second electrodes, and
the second substrate includes the plurality of third electrodes.

16. The electrophoretic element according to claim 1,
wherein one of the first substrate and the second substrate includes the plurality of second electrodes and the plurality of third electrodes.

17. A display device comprising:
a self-luminous display panel; and
the electrophoretic element according to claim 1, configured to overlap the display panel.
